(19) United States
(12) Patent Application Publication
(10) Pub. No.: US 2026/0309099 A1
(43) Pub. Date: Oct. 8, 2026

(54) GAS TURBINE OPERATION METHOD AND GAS TURBINE EQUIPMENT CAPABLE OF EXECUTING SAME

(71) Applicant: MITSUBISHI HEAVY INDUSTRIES, LTD., Tokyo (JP)

(72) Inventors: Tatsuya HAGITA, Tokyo (JP); Mitsuhiro KARISHUKU, Tokyo (JP); Hiromi KOIZUMI, Tokyo (JP); Nozomi SAITO, Tokyo (JP); Masaya HIRANO, Tokyo (JP); Yoshinori MATSUBARA, Tokyo (JP); Kohsuke KIKUCHI, Tokyo (JP)

(21) Appl. No.: 19/478,554

(22) PCT Filed: May 20, 2024
(86) PCT No.: PCT/JP2024/018484

§ 371 Date: Oct. 24, 2025

(30) Foreign Application Priority Data
Jun. 12, 2023 (JP) 2023-096016

(51) Int. Cl. F02C 9/40; F02C 7/232; F23R 3/36

(52) U.S. Cl. CPC F02C 9/40; F02C 7/232; F23R 3/36

(57) ABSTRACT

This gas turbine operation method includes executing: a first fuel single firing step of supplying only a first fuel to a first nozzle of a first burner, and not supplying the first fuel and a second fuel to a second nozzle for each of a plurality of second burners; a co-firing step of supplying only the first fuel to the first nozzle, and supplying only the second fuel to the second nozzle; a second fuel single firing preparation step of supplying the second fuel only to the second nozzle, without supplying the first fuel and the second fuel to the first nozzle; and a second fuel single firing step of supplying only the second fuel to the first nozzle and the second nozzle.

### TECHNICAL FIELD

The present disclosure relates to an operation method of a gas turbine and gas turbine equipment capable of executing the same.

Priority is claimed on Japanese Patent Application No. 2023-096016 filed on Jun. 12, 2023, the content of which is incorporated herein by reference.

BACKGROUND ART

A gas turbine includes a compressor that compresses air, a combustor that burns fuel with the air compressed by the compressor to generate combustion gas, and a turbine that is driven by the combustion gas from the combustor. The combustor includes a cylinder in which the fuel can be burned, and a plurality of burners that can inject the fuel into the cylinder together with the compressed air. Each of the plurality of burners includes an air flow channel frame through which air can flow and that can inject the air into the cylinder, and a nozzle that can inject the fuel into the air flow channel frame.

In the above-described gas turbine, two types of fuel may be used. PTL 1 discloses a fuel supply system that can supply two types of fuel to a combustor. The fuel supply system includes a first fuel line through which a first fuel can flow, a second fuel line through which a second fuel can flow, an integrated line through which the first fuel and the second fuel can flow, and branch lines that branch from the integrated line and further branch to each of a plurality of nozzles. Both the first fuel line and the second fuel line are connected to one end of the integrated line. A three-way valve is provided at one end of the integrated line. The three-way valve can achieve the following three forms. A first form is a form in which only the first fuel from the first fuel line is guided to the integrated line. A second form is a form in which only the second fuel from the second fuel line is guided to the integrated line. A third form is a form in which the first fuel from the first fuel line and the second fuel from the second fuel line are guided to the integrated line. Each branch line is connected to any one nozzle of the plurality of nozzles. Further, a nozzle valve is provided in each branch line.

In the fuel supply system, in a case where the first fuel and the second fuel are simultaneously supplied to the combustor, the above-described third form is adopted. That is, in this case, the first fuel from the first fuel line and the second fuel from the second fuel line are guided to the integrated line. Therefore, in this fuel supply system, the first fuel and the second fuel are mixed in the integrated line to become a mixed fuel, and then the mixed fuel is injected from the plurality of nozzles of the combustor.

### CITATION LIST

### Patent Literature

[PTL 1] Japanese Unexamined Patent Application Publication No, 2009-210200

### SUMMARY OF INVENTION

### Technical Problem

In a case where two types of fuel are used as the fuel for the gas turbine, it is conceivable that the fuel is switched from the first fuel to the second fuel during the operation of the gas turbine. In the gas turbine, even in a case where the fuel is switched during the operation of the gas turbine as described above, stable fuel combustion is required.

Therefore, an object of the present disclosure is to provide a technique that enables the stable fuel combustion even during a fuel switching process.

### Solution to Problem

An operation method of a gas turbine as an aspect of the present disclosure for achieving the above-described object is applied to the following gas turbine.

The gas turbine includes a compressor capable of compressing air to generate compressed air, a combustor capable of burning fuel in the compressed air to generate combustion gas, and a turbine capable of being driven by the combustion gas. The combustor includes a cylinder in which the fuel is capable of being burned, and a plurality of burners capable of injecting the fuel into the cylinder together with the compressed air. The plurality of burners include a first burner and a plurality of second burners excluding the first burner. The first burner and the plurality of second burners each include an air flow channel frame capable of allowing the air to flow and capable of injecting the air into the cylinder, and a nozzle capable of injecting the fuel into the air flow channel frame.

The operation method of a gas turbine includes executing a fuel switching step of switching the fuel to be supplied to the combustor from a first fuel to a second fuel.

The fuel switching step includes a first-fuel-exclusive combustion step of supplying only the first fuel to a first nozzle that is the nozzle of the first burner, and not supplying the first fuel and the second fuel to second nozzles that are the respective nozzles of the plurality of second burners, a co-combustion step of supplying only the first fuel to the first nozzle and supplying only the second fuel to the second nozzles after the first-fuel-exclusive combustion step, a second-fuel-exclusive combustion preparation step of not supplying the first fuel and the second fuel to the first nozzle and supplying the second fuel only to the second nozzles after the co-combustion step, and a second-fuel-exclusive combustion step of supplying only the second fuel to the first nozzle and the second nozzles after the second-fuel-exclusive combustion preparation step.

In the present aspect, even when one fuel of two types of fuel is inferior to the other fuel in fuel characteristics, the deficiency can be compensated for by the combustion of the other fuel, and thus the stable fuel combustion is enabled even during the fuel switching process.

Gas turbine equipment as another aspect of the present disclosure for achieving the above-described object includes: a compressor capable of compressing air to generate compressed air; a combustor capable of burning fuel in the compressed air to generate combustion gas; a turbine capable of being driven by the combustion gas; and a fuel supply system capable of supplying a first fuel and a second fuel to the combustor.

The combustor includes a cylinder in which the fuel is capable of being burned, and a plurality of burners capable of injecting the fuel into the cylinder together with the compressed air. The plurality of burners include a first burner and a plurality of second burners excluding the first burner. The first burner and the plurality of second burners each include an air flow channel frame capable of allowing the air to flow and capable of injecting the air into the cylinder, and a nozzle capable of injecting the fuel into the air flow channel frame.

The fuel supply system includes a first fuel line connected to a supply source of the first fuel and through which the first fuel is capable of flowing, a second fuel line connected to a supply source of the second fuel and through which the second fuel is capable of flowing, a first fuel valve provided in the first fuel line, a second fuel valve provided in the second fuel line, a header line through which the first fuel and the second fuel are capable of flowing, branch lines that branch from the header line to each of the plurality of burners, and a gate valve provided in the header line and capable of partitioning the header line into a first header portion and a second header portion. First branch lines that are some of the respective branch lines of the plurality of burners branch from the first header portion. The first branch lines are connected to a first nozzle that is the nozzle of the first burner. A plurality of second branch lines excluding the first branch lines among the respective branch lines of the plurality of burners branch from the second header portion. Each of the plurality of second branch lines is connected to a second nozzle that is the nozzle of each of the plurality of second burners. The first fuel line is connected to the first header portion, and the second fuel line is connected to the second header portion.

In the present aspect, the first fuel is injected from the first nozzle, and while the first fuel is being burned, the second fuel is injected from the second nozzles, and thus the second fuel can be burned. Therefore, in the present aspect, even when one fuel of two types of fuel is inferior to the other fuel in fuel characteristics, the deficiency can be compensated for by the combustion of the other fuel, and thus the stable fuel combustion is enabled even during the fuel switching process.

### Advantageous Effects of Invention

In the aspects of the present disclosure, the stable fuel combustion is enabled even during the fuel switching process.

### BRIEF DESCRIPTION OF DRAWINGS

FIG. 1 is a schematic diagram showing a configuration of a gas turbine according to an embodiment of the present disclosure.

FIG. 2 is a partial sectional view around a combustor of the gas turbine according to the embodiment of the present disclosure.

FIG. 3 is a view taken along arrow III in FIG. 2.

FIG. 4 is a functional block diagram of a control device according to the embodiment of the present disclosure.

FIG. 5 is a diagram showing the content of a first fuel switching step according to the embodiment of the present disclosure,

FIG. 6 is a diagram showing the content of a modification example of the first fuel switching step according to the embodiment of the present disclosure.

FIG. 7 is a diagram showing the content of a second fuel switching step according to the embodiment of the present disclosure.

FIG. 8 is a diagram showing the content of a third fuel switching step according to the embodiment of the present disclosure.

FIG. 9 is a diagram showing the content of a fourth fuel switching step according to the embodiment of the present disclosure.

FIG. 10 is a diagram showing the content of a fuel switching step in a first comparative example.

FIG. 11 is a diagram showing the content of a fuel switching step in a second comparative example.

FIG. 12 is a diagram schematically showing the content of the first fuel switching step according to the embodiment of the present disclosure.

### DESCRIPTION OF EMBODIMENTS

Hereinafter, an embodiment of an operation method of a gas turbine and gas turbine equipment capable of executing the same according to the present disclosure will be described in detail with reference to the accompanying drawings.

### Configuration of Gas Turbine Equipment

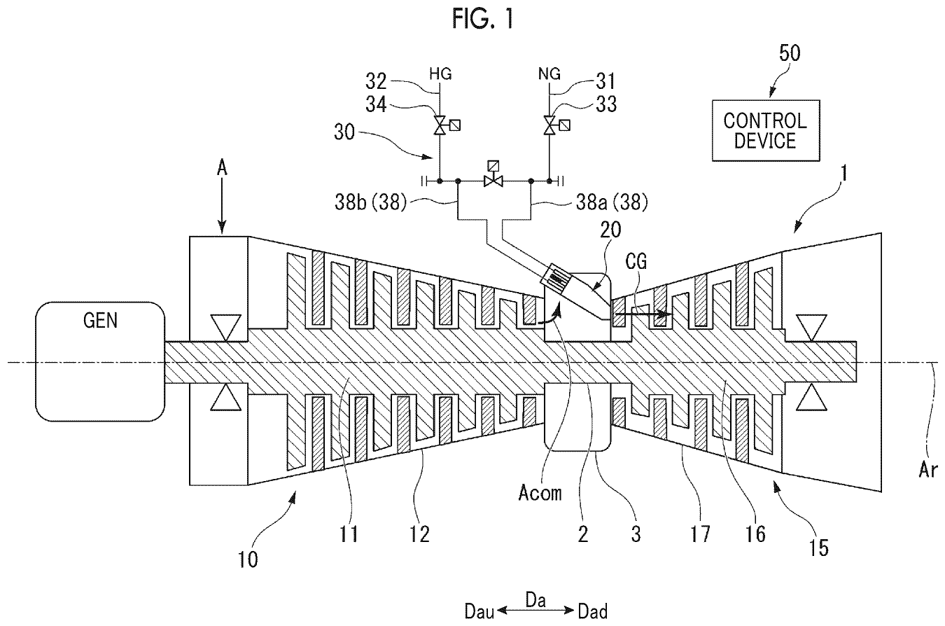

As shown in FIG. 1, the gas turbine equipment according to the present embodiment includes a gas turbine 1, a fuel supply system 30 that can supply fuel to the gas turbine 1, and a control device 50.

The gas turbine 1 includes a compressor 10 that can compress air A to generate compressed air Acom, a combustor 20 that can burn the fuel in the compressed air Acom to generate combustion gas CG, and a turbine 15 that can be driven by the combustion gas CG.

The compressor 10 includes a compressor rotor 11 that rotates around a rotor axis Ar and a compressor casing 12 that covers the compressor rotor 11. The turbine 15 includes a turbine rotor 16 that rotates around the rotor axis Ar and a turbine casing 17 that covers the turbine rotor 16. In addition, hereinafter, a direction in which the rotor axis Ar extends is referred to as a rotor axial direction Da, one side of both sides of the rotor axial direction Da is referred to as an axial upstream side Dau, and the other side thereof is referred to as an axial downstream side Dad.

The compressor 10 is disposed on the axial upstream side Dau with respect to the turbine 15. The compressor rotor 11 and the turbine rotor 16 are located on the same rotor axis Ar, and are connected to each other to form a gas turbine rotor 2. For example, a rotor of a generator GEN is connected to the gas turbine rotor 2.

The gas turbine 1 further includes an intermediate casing 3 disposed between the compressor casing 12 and the turbine casing 17. The compressed air Acom from the compressor 10 flows into the intermediate casing 3. The combustor 20 is attached to the intermediate casing 3.

The fuel supply system 30 is connected to the combustor 20. The combustor 20 can generate the combustion gas CG by burning the fuel from the fuel supply system 30 in the compressed air Acom from the compressor 10.

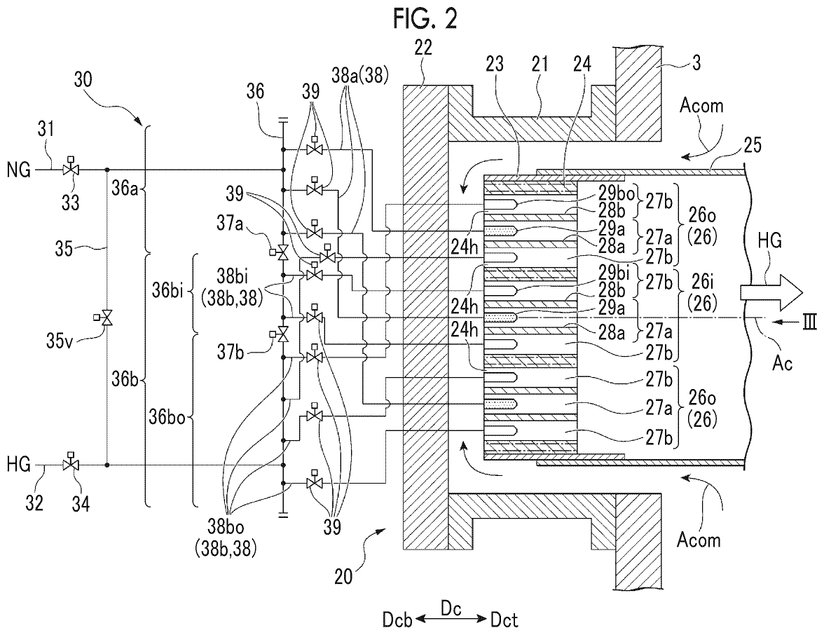

As shown in FIG. 2, the combustor 20 includes an outer cylinder 21, an end cover 22, an inner cylinder 23, an air hole plate 24, a combustion cylinder 25, and a plurality of burner groups 26. Each of the outer cylinder 21, the inner cylinder 23, and the combustion cylinder 25 has a cylindrical shape around a combustor axis Ac. Here, a direction in which the combustor axis Ac extends is referred to as a combustor axial direction Dc, one side in the combustor axial direction De is referred to as a base end side Dcb, and the other side in the combustor axial direction Dc is referred to as a tip side Dct.

An end of the outer cylinder 21 on the tip side Dct is connected to the intermediate casing 3. An end of the base end side Dcb of the outer cylinder 21 is closed by the end cover 22. The inner cylinder 23 is disposed with a spacing on an inner peripheral side of the outer cylinder 21. A space between the inner peripheral side of the outer cylinder 21 and an outer peripheral side of the inner cylinder 23 forms a flow channel of the compressed air Acom that has flowed into the intermediate casing 3. The air hole plate 24 is disposed on the inner peripheral side of the inner cylinder 23. In addition, the air hole plate 24 is disposed with a spacing from the end cover 22 in the combustor axial direction Dc. A space between the end cover 22 and the air hole plate 24 forms a flow channel of the compressed air Acom. The flow channel is connected to the flow channel between the inner peripheral side of the outer cylinder 21 and the outer peripheral side of the inner cylinder 23. The air hole plate 24 is fixed to the end cover 22 via a support and the like. The inner cylinder 23 is fixed to the air hole plate 24. A plurality of air holes 24h penetrating in the combustor axial direction Dc are formed in the air hole plate 24. The combustion cylinder 25 is fixed to the tip side Dct of the inner cylinder 23. An inner peripheral side of the combustion cylinder 25 forms a combustion space in which the fuel is burned.

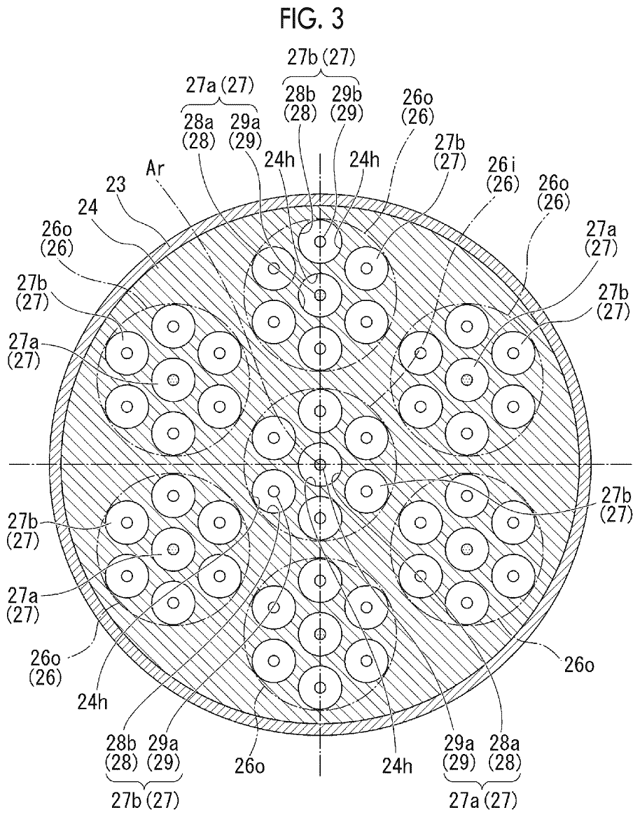

As shown in FIG. 3, the plurality of burner groups 26 include an inner burner group 26i and a plurality of outer burner groups 26o. The inner burner group 26i is disposed on the combustor axis Ac. The plurality of outer burner groups 26o are disposed around the inner burner group 26i. Each of the plurality of burner groups 26 includes a first burner 27a and a plurality of second burners 27b. The plurality of second burners 27b are disposed around the first burner 27a. The first burner 27a and the plurality of second burners 27b each include an air flow channel frame 28 through which the air can flow and that can inject the air into the combustion cylinder 25, and a nozzle 29 that is disposed in the air flow channel frame 28 and that can inject the fuel into the air flow channel frame 28. Hereinafter, the nozzle 29 of the first burner 27a is referred to as a first nozzle 29a, and the nozzle 29 of the second burner 27b is referred to as a second nozzle 29b. In addition, the air flow channel frame 28 of the first burner 27a is referred to as a first air flow channel frame 28a, and the air flow channel frame 28 of the second burner 27b is referred to as a second air flow channel frame 28b. In addition, in FIG. 3, one burner group 26 includes one first burner 27a and six second burners 27b. However, in practice, one burner group 26 includes several first burners 27a and several tens of second burners 27b. For this reason, the combustor 20 according to the present embodiment is called a multi-cluster combustor.

An inner peripheral surface of the air flow channel frame 28 of each burner 27 is formed by an inner peripheral surface of any of the plurality of air holes 24h of the air hole plate 24. Therefore, each of the air flow channel frames 28 is formed by a part of the air hole plate 24.

As shown in FIG. 2, the compressed air Acom that has flowed into the intermediate casing 3 flows into the air flow channel frame 28 of each of the plurality of burners 27 through the flow channel between the inner peripheral side of the outer cylinder 21 and the outer peripheral side of the inner cylinder 23 and the flow channel between the end cover 22 and the air hole plate 24, as described above. The nozzle 29 of each of the plurality of burners 27 injects the fuel into the air flow channel frame 28. The air and the fuel are injected into the combustion cylinder 25 from the air flow channel frame 28 of each of the plurality of burners 27. The fuel injected into the combustion cylinder 25 is burned in the air also injected into the combustion cylinder 25. The combustion gas formed by the combustion flows into the turbine 15.

The fuel supply system 30 can supply a first fuel NG and a second fuel HG to the combustor 20. In the present embodiment, the first fuel NG is natural gas, and the second fuel HG is hydrogen gas. As shown in FIG. 2, the fuel supply system 30 includes a first fuel line 31, a second fuel line 32, a first fuel valve 33 provided in the first fuel line 31, a second fuel valve 34 provided in the second fuel line 32, a header line 36, a first gate valve 37a and a second gate valve 37b that are provided in the header line 36, a connection line 35, a mixing ratio regulating valve 35v provided in the connection line 35, branch lines 38 that branch from the header line 36 to each of the plurality of burners 27, and a nozzle valve 39 provided in the branch line 38 for each of the plurality of burners 27.

The first fuel line 31 is a line connected to a supply source of the first fuel NG and through which the first fuel NG can flow. The second fuel line 32 is a line connected to a supply source of the second fuel HG and through which the second fuel HG can flow.

The first gate valve 37a provided in the header line 36 can partition the header line 36 into a first header portion 36a and a second header portion 36b, The second gate valve 37b provided in the header line 36 can partition the second header portion 36b into a first side second header portion 36bi on the first header portion 36a side and a second side second header portion 36bo that is the remaining portion of the second header portion 36b. The first fuel line 31 is connected to the first header portion 36a in the header line 36. The second fuel line 32 is connected to the second side second header portion 36bo in the header line 36.

A plurality of first branch lines 38a, which are some of the respective branch lines 38 of the plurality of burners 27, branch from the first header portion 36a. Each of the plurality of first branch lines 38a is connected to the first nozzle 29a that is the nozzle 29 of each of the plurality of first burners 27a. A plurality of second branch lines 38b, which are the branch lines 38 excluding the plurality of first branch lines 38a among the respective branch lines 38 of the plurality of burners 27, branch from the second header portion 36b. Each of the plurality of second branch lines 38b is connected to the second nozzle 29b that is the nozzle 29 of each of the plurality of second burners 27b. A plurality of first side second branch lines 38bi, which are some of the plurality of second branch lines 38b, branch from the first side second header portion 36bi that is a portion of the second header portion 36b. The plurality of first side second branch lines 38bi are connected to a plurality of first side second nozzles 29bi that are some of a plurality of second nozzles 29b. A plurality of second side second branch lines 38bo, which are the second branch lines 38b excluding the plurality of first side second branch lines 38bi among the plurality of second branch lines 38b, branch from the second side second header portion 36bo that is a portion of the second header portion 36b. The plurality of second side second branch lines 38bo is connected to a plurality of second side second nozzles 29bo that are the second nozzles 29b excluding the plurality of first side second nozzles 29bi among the plurality of second nozzles 29b.

The first side second nozzles 29bi are the second nozzles 29b of the inner burner group 26i among the plurality of burner groups 26. The second side second nozzles 29bo are the second nozzles 29b of the outer burner groups 26o among the plurality of burner groups 26.

The connection line 35 connects a position in the first fuel line 31 between a position at which the first fuel line 31 is connected to the header line 36 and a position at which the first fuel valve 33 is provided, and a position in the second fuel line 32 between a position at which the second fuel line 32 is connected to the header line 36 and a position at which the second fuel valve 34 is provided.

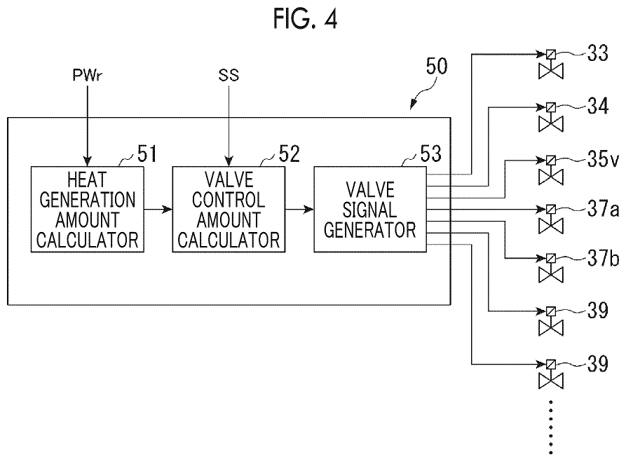

As shown in FIG. 4, the control device 50 includes a heat generation amount calculator 51, a valve control amount calculator 52, and a valve signal generator 53. A required output PWr for the gas turbine 1 is input from the outside to the heat generation amount calculator 51. The heat generation amount calculator 51 obtains a total heat generation amount generated by the combustion of the fuel supplied to the combustor 20 in accordance with the required output PWr. A switching command SS for the fuel is input from the outside to the valve control amount calculator 52, and the total heat generation amount is input from the heat generation amount calculator 51. The valve control amount calculator 52 obtains control amounts of the plurality of valves described above in accordance with the switching command SS and the total heat generation amount. The control amounts of the plurality of valves are input to the valve signal generator 53 from the valve control amount calculator 52, The valve signal generator 53 creates a valve signal of each valve in accordance with the control amount of each of the plurality of valves, and sends the valve signal to the corresponding valve.

The control device 50 can execute a fuel switching step of switching the fuel to be supplied to the combustor 20 from the first fuel NG to the second fuel HG. The control device 50 can execute a first fuel switching step, a second fuel switching step, a third fuel switching step, and a fourth fuel switching step as the fuel switching steps. During the execution of these fuel switching steps, the gas turbine output is not changed. In other words, during the execution of these fuel switching steps, the total heat generation amount generated by the combustion of the fuel supplied to the combustor 20 is not changed.

### First Fuel Switching Step According to Present Embodiment

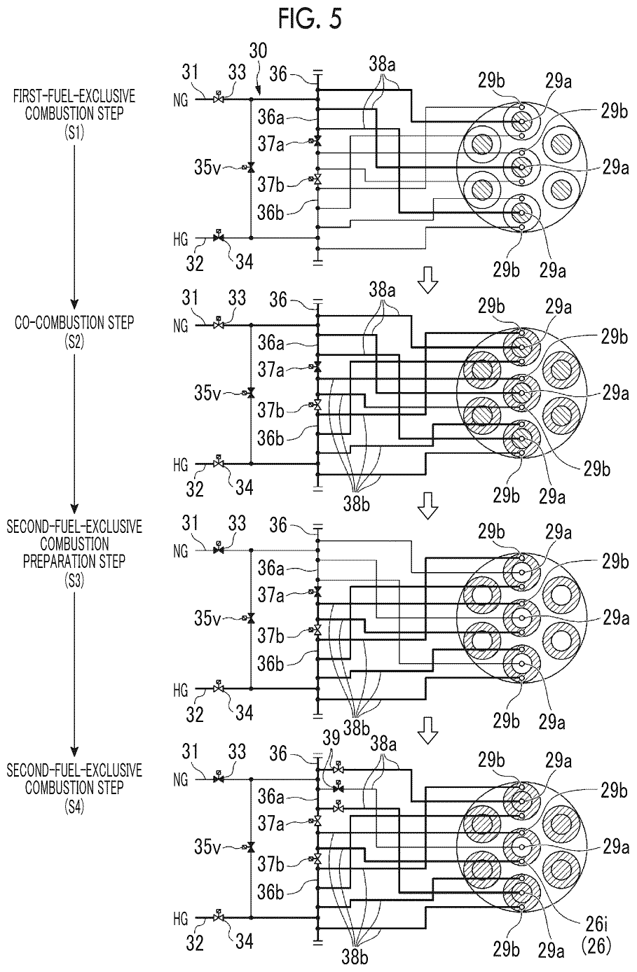

The first fuel switching step according to the present embodiment will be described with reference to FIG. 5. The first fuel switching step is a step of switching the fuel from the first fuel NG to the second fuel HG when the gas turbine output is low. The first fuel switching step includes a first-fuel-exclusive combustion step S1, a co-combustion step S2, a second-fuel-exclusive combustion preparation step S3, and a second-fuel-exclusive combustion step S4. In FIG. 5, for simplification, some of the first nozzles 29a and some of the second nozzles 29b are omitted.

In the first-fuel-exclusive combustion step S1, the control device 50 opens the first fuel valve 33, closes the second fuel valve 34, closes the first gate valve 37a, opens the second gate valve 37b, and closes the mixing ratio regulating valve 35v. As a result, the second fuel HG does not flow into the header line 36, and only the first fuel NG flows into the first header portion 36a in the header line 36. The first fuel NG that has flowed into the first header portion 36a flows into a plurality of first nozzles 29a via a plurality of first branch lines 38a that branch from the first header portion 36a, and is injected from the plurality of first nozzles 29a. In this case, all the nozzle valves 39 provided in the plurality of first branch lines 38a are in an open state.

In the first-fuel-exclusive combustion step S1, only the first fuel NG is supplied to the plurality of first nozzles 29a, and the first fuel NG and the second fuel HG are not supplied to the plurality of second nozzles 29b.

Therefore, in the first-fuel-exclusive combustion step S1, only the first fuel NG injected from the first nozzle 29a is burned.

In order to carry out the first-fuel-exclusive combustion step S1, the heat generation amount calculator 51 of the control device 50 obtains the total heat generation amount generated by the combustion of the fuel supplied to the combustor 20, to reduce the gas turbine output. The valve control amount calculator 52 obtains a total flow rate of the first fuel NG corresponding to the total heat generation amount. The valve control amount calculator 52 selects the nozzle 29 that supplies the first fuel NG from among the plurality of nozzles 29 based on the total flow rate of the first fuel NG, and determines the flow rate of the first fuel NG supplied to each nozzle 29. Here, the valve control amount calculator 52 selects the plurality of first nozzles 29a from among the plurality of nozzles 29. Then, the valve control amount calculator 52 determines the open/closed states of the first fuel valve 33, the second fuel valve 34, the first gate valve 37a, the second gate valve 37b, and the mixing ratio regulating valve 35v such that the first fuel NG is supplied only to the plurality of first nozzles 29a, and determines a valve opening degree of each nozzle valve 39 provided in the plurality of first branch lines 38a. The valve signal generator 53 creates the valve signal for each of the plurality of valves in accordance with the content determined by the valve control amount calculator 52 for the plurality of valves, and sends each valve signal to the corresponding valve.

The control device 50 executes the co-combustion step S2 after the first-fuel-exclusive combustion step S1. In the co-combustion step S2, the control device 50 opens the first fuel valve 33, opens the second fuel valve 34, closes the first gate valve 37a, opens the second gate valve 37b, and closes the mixing ratio regulating valve 35v. Therefore, in a process of going from the first-fuel-exclusive combustion step S1 to the co-combustion step S2, the second fuel valve 34 among the plurality of valves is changed from the closed state to the open state. As a result, the first fuel NG continues to flow into the first header portion 36a in the header line 36, and the second fuel HG flows into the second header portion 36b in the header line 36. The first fuel NG that has flowed into the first header portion 36a flows into a plurality of first nozzles 29a via the plurality of first branch lines 38a that branch from the first header portion 36a, and is injected from the plurality of first nozzles 29a. In addition, the second fuel HG that has flowed into the second header portion 36b flows into the plurality of second nozzles 29b via the plurality of second branch lines 38b that branch from the second header portion 36b, and is injected from the plurality of second nozzles 29b. In this case, the number of the nozzles 29 that inject the second fuel HG is larger than the number of the nozzles 29 that inject the first fuel NG. In other words, a total cross-sectional area of the air flow channel frame 28 from which the second fuel HG is injected is larger than a total cross-sectional area of the air flow channel frame 28 from which the first fuel NG is injected.

As described above, in the co-combustion step S2, only the first fuel NG is supplied to the plurality of first nozzles 29a, and only the second fuel HG is supplied to the plurality of second nozzles 29b. Therefore, in the co-combustion step S2, the first fuel NG injected from the first nozzle 29a is burned, and the second fuel HG injected from the second nozzles 29b is burned.

The valve control amount calculator 52 of the control device 50 obtains the total flow rate of the first fuel NG and a total flow rate of the second fuel HG corresponding to the total heat generation amount obtained by the heat generation amount calculator 51. Since the total heat generation amount in the first-fuel-exclusive combustion step S1 and the total heat generation amount in the co-combustion step S2 are the same as each other, the total flow rate of the first fuel NG in the co-combustion step S2 in which the second fuel HG is supplied to the combustor 20 is smaller than the total flow rate of the first fuel NG in the first-fuel-exclusive combustion step S1 of not supplying the second fuel HG to the combustor 20. The valve control amount calculator 52 selects the nozzle 29 that supplies the first fuel NG from among the plurality of nozzles 29 based on the total flow rate of the first fuel NG, and determines the flow rate of the first fuel NG supplied to each nozzle 29. Further, the valve control amount calculator 52 selects the nozzle 29 that supplies the second fuel HG from among the plurality of nozzles 29, based on the total flow rate of the second fuel HG, and determines the flow rate of the second fuel HG supplied to each nozzle 29. Here, the valve control amount calculator 52 selects the plurality of first nozzles 29a as the nozzles 29 for supplying the first fuel NG from the plurality of nozzles 29. In addition, the valve control amount calculator 52 selects the plurality of second nozzles 29b as the nozzles 29 for supplying the second fuel HG from the plurality of nozzles 29. Then, the valve control amount calculator 52 determines the open/closed states of the first fuel valve 33, the second fuel valve 34, the first gate valve 37a, the second gate valve 37b, and the mixing ratio regulating valve 35v such that the first fuel NG is supplied only to the plurality of first nozzles 29a, and the second fuel HG is supplied only to the plurality of second nozzles 29b. Further, the valve control amount calculator 52 determines the valve opening degree of each nozzle valve 39 provided in the plurality of first branch lines 38a and the valve opening degree of each nozzle valve 39 provided in the plurality of second branch lines 38b.

The control device 50 executes the second-fuel-exclusive combustion preparation step S3 after the co-combustion step S2. In the second-fuel-exclusive combustion preparation step S3, the control device 50 closes the first fuel valve 33, opens the second fuel valve 34, closes the first gate valve 37a, opens the second gate valve 37b, and closes the mixing ratio regulating valve 35v. Therefore, in a process of going from the co-combustion step S2 to the second-fuel-exclusive combustion preparation step S3, the first fuel valve 33 among the plurality of valves is changed from the open state to the closed state. As a result, the second fuel HG continues to flow into the second header portion 36b in the header line 36, while the first fuel NG does not flow into the header line 36. The second fuel HG that has flowed into the second header portion 36b flows into the plurality of second nozzles 29b via the plurality of second branch lines 38b that branch from the second header portion 36b, and is injected from the plurality of second nozzles 29b, as in the co-combustion step S2.

As described above, in the second-fuel-exclusive combustion preparation step S3, the first fuel NG and the second fuel HG are not supplied to the plurality of first nozzles 29a, and only the second fuel HG is supplied to the plurality of second nozzles 29b. Therefore, in the second-fuel-exclusive combustion preparation step S3, only the second fuel HG injected from the second nozzles 29b is burned.

The valve control amount calculator 52 of the control device 50 obtains the total flow rate of the second fuel HG corresponding to the total heat generation amount obtained by the heat generation amount calculator 51. Since the total heat generation amount in the co-combustion step S2 and the total heat generation amount in the second-fuel-exclusive combustion preparation step S3 are the same as each other, the total flow rate of the second fuel HG in the second-fuel-exclusive combustion preparation step S3 of supplying only the second fuel HG to the combustor 20 is larger than the total flow rate of the second fuel HG in the co-combustion step S2 of supplying the first fuel NG and the second fuel HG to the combustor 20. The valve control amount calculator 52 selects the nozzle 29 that supplies the second fuel HG from among the plurality of nozzles 29, based on the total flow rate of the second fuel HG, and determines the flow rate of the second fuel HG supplied to each nozzle 29. Here, the valve control amount calculator 52 selects the plurality of second nozzles 29b as the nozzles 29 for supplying the second fuel HG from the plurality of nozzles 29. Then, the valve control amount calculator 52 determines the open/closed states of the first fuel valve 33, the second fuel valve 34, the first gate valve 37a, the second gate valve 37b, and the mixing ratio regulating valve 35v such that the second fuel HG is supplied only to the plurality of second nozzles 29b. Furthermore, the valve control amount calculator 52 determines the valve opening degree of each nozzle valve 39 provided in the plurality of second branch lines 38b.

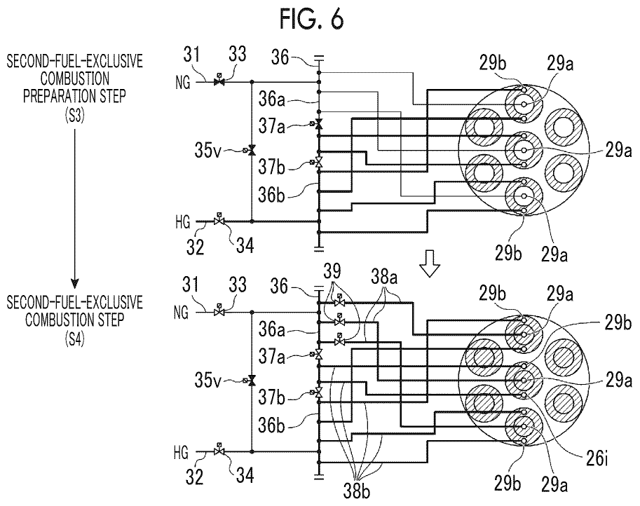

The control device 50 executes the second-fuel-exclusive combustion step S4 after the second-fuel-exclusive combustion preparation step S3. In the second-fuel-exclusive combustion step S4, the control device 50 closes the first fuel valve 33, opens the second fuel valve 34, opens the first gate valve 37a, opens the second gate valve 37b, and closes the mixing ratio regulating valve 35v. Therefore, in a process of going from the second-fuel-exclusive combustion preparation step S3 to the second-fuel-exclusive combustion step S4, the first gate valve 37a among the plurality of valves is changed from the closed state to the open state. As a result, only the second fuel HG flows into the entire header line 36. The second fuel HG that has flowed into the header line 36 flows into the plurality of second nozzles 29b via the plurality of second branch lines 38b that branch from the second header portion 36b in the header line 36 and is injected from the plurality of second nozzles 29b, and also flows into the plurality of first nozzles 29a via the plurality of first branch lines 38a that branch from the first header portion 36a in the header line 36 and is injected from the plurality of first nozzles 29a. However, in the present embodiment, the second fuel HG is not supplied to the first nozzle 29a included in the inner burner group 26i among the plurality of first nozzles 29a. That is, in the present embodiment, the nozzle valve 39 of the first branch line 38a connected to the first nozzle 29a of the inner burner group 26i among the nozzle valves 39 provided in the plurality of first branch lines 38a is in the closed state. This is because the second fuel HG should not be supplied to the first nozzle 29a of the inner burner group 26i due to a restriction on the total flow rate of the second fuel HG supplied to the combustor 20. Therefore, in the second-fuel-exclusive combustion step S4, in accordance with the total flow rate of the second fuel HG supplied to the combustor 20, as shown in FIG. 6, all the nozzle valves 39 provided in the plurality of first branch lines 38a may be opened to supply the second fuel HG to all the first nozzles 29a.

In the second-fuel-exclusive combustion step S4, only the second fuel HG is supplied to all the nozzles 29 excluding the first nozzle 29a included in the inner burner group 26i among the plurality of nozzles 29. Therefore, in the second-fuel-exclusive combustion step S4, only the second fuel HG injected from the second nozzles 29b and the second fuel HG injected from some of the first nozzles 29a are burned.

The total flow rate of the second fuel HG in the second-fuel-exclusive combustion step S4 is the same as the total flow rate of the second fuel HG in the second-fuel-exclusive combustion preparation step S3. The valve control amount calculator 52 selects the nozzle 29 that supplies the second fuel HG from among the plurality of nozzles 29, based on the total flow rate of the second fuel HG, and determines the flow rate of the second fuel HG supplied to each nozzle 29. Here, the valve control amount calculator 52 selects the plurality of second nozzles 29b and some of the plurality of first nozzles 29a as the nozzles 29 for supplying the second fuel HG from among the plurality of nozzles 29. Then, the valve control amount calculator 52 determines the open/closed states of the first fuel valve 33, the second fuel valve 34, the first gate valve 37a, the second gate valve 37b, and the mixing ratio regulating valve 35v such that the second fuel HG is supplied only to the plurality of second nozzles 29b and some of the plurality of first nozzles 29a. Furthermore, the valve control amount calculator 52 determines the valve opening degree of each nozzle valve 39 provided in the plurality of branch lines 38.

### Operations and Effects of First Fuel Switching Step According to Present Embodiment

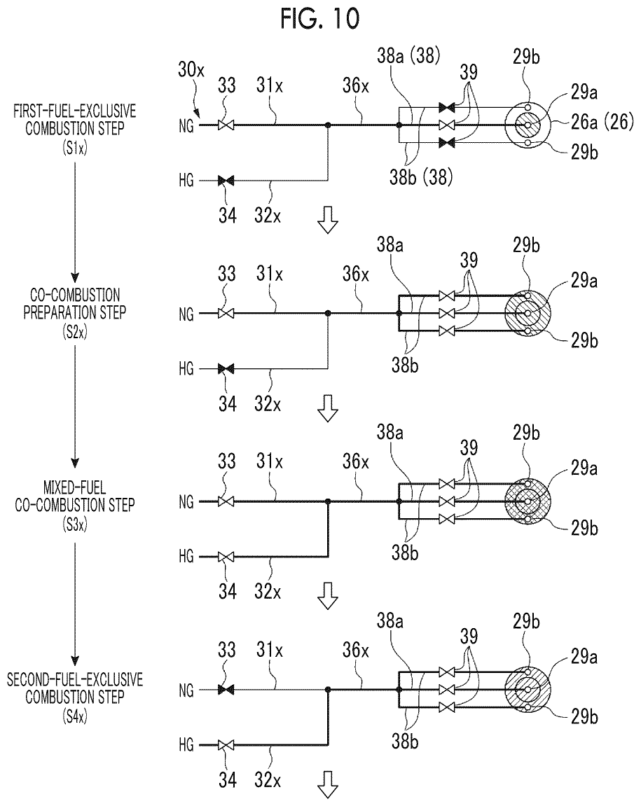

The operations and effects of two comparative examples and the operations and effects of the first fuel switching step according to the present embodiment will be described with reference to FIG. 10 to FIG. 12. The combustors in the two comparative examples are the same as the combustor 20 according to the present embodiment. Meanwhile, the fuel supply systems in the two comparative examples are different from the fuel supply system 30 according to the present embodiment. In addition, in FIGS. 10 to 12, for the sake of simplification of description, only the first nozzle 29a and some of the second nozzles 29b in one outer burner group 26o are shown.

### (1) First Comparative Example

A first comparative example will be described with reference to FIG. 10.

A fuel supply system 30x in the first comparative example includes a first fuel line 31x through which the first fuel NG can flow, a second fuel line 32x through which the second fuel HG can flow, an integrated line 36x through which the first fuel NG and the second fuel HG can flow, and branch lines 38 that branch from the integrated line 36x to each of the plurality of nozzles 29. The first fuel line 31x and the second fuel line 32x are both connected to one end of the integrated line 36x. The first fuel valve 33 is provided in the first fuel line 31x, and the second fuel valve 34 is provided in the second fuel line 32x. The nozzle valve 39 is provided in the branch lines 38 that branch to each of the plurality of nozzles 29. Some of the branch lines 38 that branch to each of the plurality of nozzles 29 form the first branch lines 38a connected to the first nozzles 29a, and the other branch lines 38 form the second branch lines 38b connected to the second nozzles 29b.

In the fuel supply system 30x in the first comparative example, when the first fuel valve 33 and the second fuel valve 34 are opened, the first fuel NG that has passed through the first fuel valve 33 and the second fuel HG that has passed through the second fuel valve 34 are always mixed in the integrated line 36x. For this reason, in the fuel supply system 30x in the first comparative example, when the first fuel valve 33 and the second fuel valve 34 are opened, it is not possible to supply only the first fuel NG to some of the plurality of nozzles 29, and to supply only the second fuel HG to the remaining nozzles 29.

A fuel switching step in the first comparative example includes a first-fuel-exclusive combustion step S1x, a co-combustion preparation step S2x, a mixed-fuel co-combustion step S3x, and a second-fuel-exclusive combustion step S4x. The gas turbine output is not changed even during the execution of the fuel switching step in the first comparative example. In other words, during the execution of these fuel switching steps, the total heat generation amount generated by the combustion of the fuel supplied to the combustor is not changed.

In the first-fuel-exclusive combustion step S1x, the first fuel valve 33 is opened, the second fuel valve 34 is closed, the nozzle valve 39 of the first branch line 38a is opened, and the nozzle valve 39 of the second branch line 38b is closed. As a result, the second fuel HG does not flow into the integrated line 36x, and only the first fuel NG flows into the integrated line 36x. The first fuel NG that has flowed into the integrated line 36x flows only into the first nozzle 29a via the first branch line 38a.

In the first-fuel-exclusive combustion step S1x, only the first fuel NG is supplied to the first nozzle 29a, and the first fuel NG and the second fuel HG are not supplied to the plurality of second nozzles 29b. Therefore, in the first-fuel-exclusive combustion step S1x, only the first fuel NG injected from the first nozzle 29a is burned, as in the first-fuel-exclusive combustion step S1 of the first fuel switching step according to the present embodiment.

In the co-combustion preparation step S2x, the first fuel valve 33 is opened, the second fuel valve 34 is closed, the nozzle valve 39 of the first branch line 38a is opened, and the nozzle valve 39 of the second branch line 38b is opened. Therefore, in a process of going from the first-fuel-exclusive combustion step S1x to the co-combustion preparation step S2x, the nozzle valve 39 of the second branch line 38b is changed from the closed state to the open state. As a result, the first fuel NG that has flowed into the integrated line 36x flows into the first nozzle 29a via the first branch line 38a and also flows into the second nozzles 29b via the second branch line 38b.

In the co-combustion preparation step S2x, only the first fuel NG is supplied to the first nozzle 29a and the plurality of second nozzles 29b. Therefore, in the co-combustion preparation step S2x, only the first fuel NG injected from the first nozzle 29a and the plurality of second nozzles 29b is burned.

In the mixed-fuel co-combustion step S3x, the first fuel valve 33 is opened, the second fuel valve 34 is opened, the nozzle valve 39 of the first branch line 38a is opened, and the nozzle valve 39 of the second branch line 38b is opened. Therefore, in a process of going from the co-combustion preparation step S2x to the mixed-fuel co-combustion step S3x, the second fuel valve 34 is changed from the closed state to the open state. As a result, the first fuel NG and the second fuel HG flow into the integrated line 36x. The first fuel NG and the second fuel HG that have flowed into the integrated line 36x are mixed therein to become a mixed fuel. The mixed fuel inside the integrated line 36x flows into the first nozzle 29a via the first branch line 38a, and also flows into the second nozzles 29b via the second branch line 38b.

In the mixed-fuel co-combustion step S3x, the mixed fuel is supplied to the first nozzle 29a and the plurality of second nozzles 29b. Therefore, in the mixed-fuel co-combustion step S3x, the mixed fuel injected from the first nozzle 29a and the plurality of second nozzles 29b is burned.

In the second-fuel-exclusive combustion step S4x, the first fuel valve 33 is closed, the second fuel valve 34 is opened, the nozzle valve 39 of the first branch line 38a is opened, and the nozzle valve 39 of the second branch line 38b is opened. Therefore, in a process of going from the mixed-fuel co-combustion step S3x to the second-fuel-exclusive combustion step S4x, the first fuel valve 33 is changed from the open state to the closed state. As a result, only the second fuel HG flows into the integrated line 36x, and the first fuel NG does not flow into the integrated line 36x. The second fuel HG that has flowed into the integrated line 36x flows into the first nozzle 29a via the first branch line 38a, and also flows into the second nozzles 29b via the second branch line 38b.

In the second-fuel-exclusive combustion step S4x, only the second fuel HG is supplied to the first nozzle 29a and the plurality of second nozzles 29b. Therefore, in the second-fuel-exclusive combustion step S4x, only the second fuel HG injected from the first nozzle 29a and the plurality of second nozzles 29b is burned, as in the second-fuel-exclusive combustion step S4 of the first fuel switching step according to the present embodiment.

Meanwhile, the natural gas, which is the first fuel NG, has characteristics such that the combustibility deteriorates and the unburned content in the combustion gas increases in a case where a fuel-air ratio is low compared to the hydrogen gas that is the second fuel HG.

On the other hand, the hydrogen gas that is the second fuel HG has characteristics such that a probability of flashback increases significantly in a case where a fuel-air ratio is higher than that of the natural gas that is the first fuel NG. However, the hydrogen gas does not deteriorate in combustibility even when the fuel-air ratio is low compared to the natural gas. Furthermore, compared to the hydrogen gas, the natural gas does not have a high probability of flashback even at a high fuel-air ratio.

That is, the natural gas has characteristics such that the combustibility is poor when the fuel-air ratio is low, and has characteristics such that the probability of flashback is not very high even when the fuel-air ratio is high. In addition, the hydrogen gas has characteristics such that the combustibility is not significantly deteriorated even when the fuel-air ratio is low, and has characteristics such that the probability of flashback is significantly increased when the fuel-air ratio is high.

In the first fuel switching step in the first comparative example described above, in the first-fuel-exclusive combustion step S1x, only the first fuel NG is injected only from the first nozzle 29a, and neither the first fuel NG nor the second fuel HG is injected from the second nozzles 29b. In addition, in the co-combustion preparation step S2x, the first fuel NG is injected from the first nozzle 29a and the plurality of second nozzles 29b. That is, only the first fuel NG is injected in the first-fuel-exclusive combustion step S1x and the co-combustion preparation step S2x.

As described above, during the execution of the fuel switching step, the total heat generation amount generated by the combustion of the fuel supplied to the combustor is not changed. For this reason, the flow rate of the first fuel NG supplied to the combustor in the co-combustion preparation step S2x is the same as the flow rate of the first fuel NG supplied to the combustor in the first-fuel-exclusive combustion step S1x. Meanwhile, the number of the nozzles 29 that inject the first fuel NG in the co-combustion preparation step S2x is larger than the number of the nozzles 29 that inject the first fuel NG in the first-fuel-exclusive combustion step S1x. Therefore, the fuel-air ratio related to the first fuel NG in the co-combustion preparation step S2x is lower than the fuel-air ratio related to the first fuel NG in the first-fuel-exclusive combustion step S1x. As described above, the first fuel NG, which is the natural gas, has characteristics of poor combustibility when the fuel-air ratio is low. For this reason, in the co-combustion preparation step S2x, the combustibility of the fuel deteriorates.

As described above, when the fuel switching step in the first comparative example is executed, the combustibility of the fuel is temporarily deteriorated in a process of switching from the first fuel NG to the second fuel HG.

### (2) Second Comparative Example

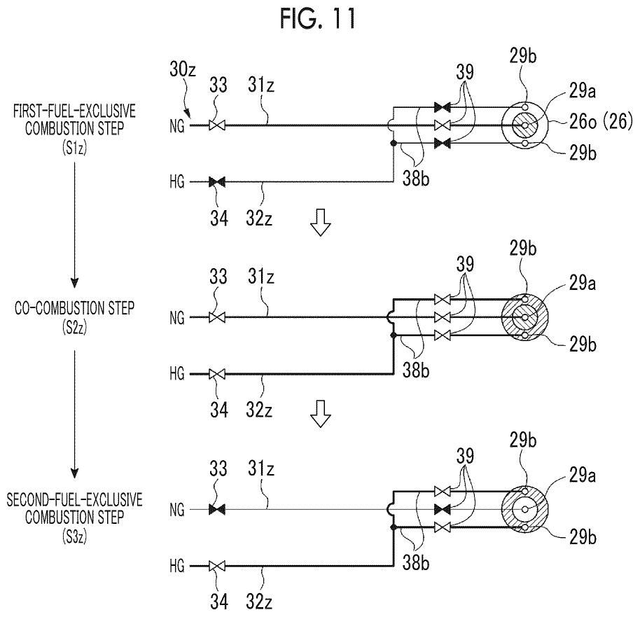

A second comparative example will be described with reference to FIG. 11.

A fuel supply system 30z in the second comparative example includes a first fuel line 31z through which the first fuel NG can flow, a second fuel line 32z through which the second fuel HG can flow, and second branch lines 38b that branch from the second fuel line 32z to each of the plurality of second nozzles 29b. The first fuel line 31z is connected to the first nozzle 29a. The first fuel valve 33 and the nozzle valve 39 for the first nozzle 29a are provided in the first fuel line 31z. The second fuel line 32z is completely independent of the first fuel line 31z. The second fuel valve 34 is provided in the second fuel line 32z. The nozzle valve 39 is provided in each of the second branch lines 38b for the plurality of second nozzles 29b.

In the fuel supply system 30z in the second comparative example, since the second fuel line 32z is completely independent of the first fuel line 31z, the first fuel NG and the second fuel HG are not mixed even when the first fuel valve 33 and the second fuel valve 34 are opened. In addition, in the fuel supply system 30z in the second comparative example, the first fuel NG can flow exclusively into the first nozzle 29a, and the second fuel HG can flow exclusively into the second nozzles 29b.

The fuel switching step in the second comparative example includes a first-fuel-exclusive combustion step S1z, a co-combustion step S2z, and a second-fuel-exclusive combustion step S3z.

In the first-fuel-exclusive combustion step S1z, the first fuel valve 33 is opened, the nozzle valve 39 for the first nozzle 29a is opened, the second fuel valve 34 is closed, and the nozzle valve 39 of the second branch line 38b is closed. As a result, only the first fuel NG is supplied to the first nozzle 29a, and the first fuel NG and the second fuel HG are not supplied to the second nozzles 29b. Therefore, in the first-fuel-exclusive combustion step S1z, only the first fuel NG injected from the first nozzle 29a is burned.

In the co-combustion step S2z, the first fuel valve 33 is opened, the nozzle valve 39 for the first nozzle 29a is opened, the second fuel valve 34 is opened, and the nozzle valve 39 of the second branch line 38b is opened. Therefore, in a process of going from the first-fuel-exclusive combustion step S1z to the co-combustion step S2z, the second fuel valve 34 is changed from the closed state to the open state, and the nozzle valve 39 of the second branch line 38b is changed from the closed state to the open state. As a result, the first fuel NG is supplied only to the first nozzle 29a, and the second fuel HG is supplied only to the plurality of second nozzles 29b. Therefore, in the co-combustion step S2z, the first fuel NG injected from the first nozzle 29a is burned, and the second fuel HG injected from the plurality of second nozzles 29b is burned.

In the second-fuel-exclusive combustion step S3z, the first fuel valve 33 is closed, the nozzle valve 39 for the first nozzle 29a is closed, the second fuel valve 34 is opened, and the nozzle valve 39 of the second branch line 38b is opened. Therefore, in a process of going from the co-combustion step S2z to the second-fuel-exclusive combustion step S3z, the first fuel valve 33 is changed from the open state to the closed state, and the nozzle valve 39 for the first nozzle 29a is changed from the open state to the closed state. As a result, only the second fuel HG is supplied to the second nozzles 29b, and the first fuel NG and the second fuel HG are not supplied to the first nozzle 29a.

In the second comparative example, since the first fuel NG cannot be supplied to the second nozzles 29b, the first-fuel-exclusive combustion step S1z is executed by supplying the first fuel NG only to the first nozzle 29a. For this reason, in the second comparative example, even when the gas turbine output is increased only by the exclusive combustion of the first fuel NG, the gas turbine output corresponding to the total number of the nozzles 29 cannot be obtained. In addition, in the second comparative example, since the second fuel HG cannot be supplied to the first nozzle 29a, the second fuel HG is supplied only to the second nozzles 29b, and the second-fuel-exclusive combustion step S3z is executed. For this reason, in the second comparative example, even when the gas turbine output is increased only by the exclusive combustion of the second fuel HG, the gas turbine output corresponding to the total number of the nozzles 29 cannot be obtained. That is, in the second comparative example, even when the gas turbine output is increased by executing the exclusive combustion of one of the first fuel NG and the second fuel HG, the gas turbine output corresponding to the total number of the nozzles 29 cannot be obtained.

### (3) First Fuel Switching Step According to Present Embodiment

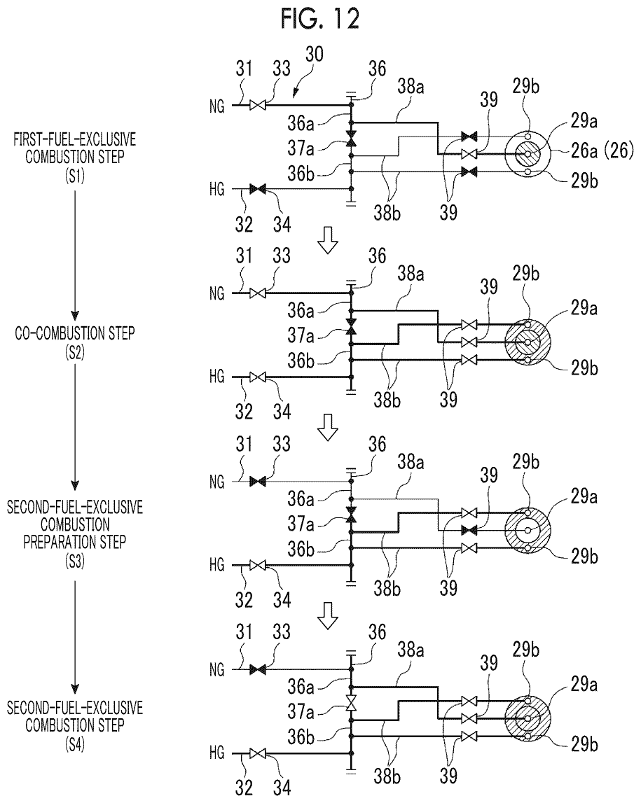

The first fuel switching step according to the present embodiment will be described again with reference to FIG. 12.

In the first-fuel-exclusive combustion step S1, the first fuel valve 33 is opened, the second fuel valve 34 is closed, and the first gate valve 37a is closed. As a result, the second fuel HG does not flow into the header line 36, and only the first fuel NG flows into the first header portion 36a in the header line 36. The first fuel NG that has flowed into the first header portion 36a flows into a plurality of first nozzles 29a via the plurality of first branch lines 38a that branch from the first header portion 36a, and is injected from the plurality of first nozzles 29a. In the first-fuel-exclusive combustion step S1, only the first fuel NG is supplied to the plurality of first nozzles 29a, and the first fuel NG and the second fuel HG are not supplied to the plurality of second nozzles 29b. Therefore, in the first-fuel-exclusive combustion step S1, only the first fuel NG injected from the first nozzle 29a is burned.

In the co-combustion step S2, the first fuel valve 33 is opened, the second fuel valve 34 is opened, and the first gate valve 37a is closed. As a result, the first fuel NG continues to flow into the first header portion 36a in the header line 36, and the second fuel HG flows into the second header portion 36b in the header line 36. The first fuel NG that has flowed into the first header portion 36a flows into a plurality of first nozzles 29a via the plurality of first branch lines 38a that branch from the first header portion 36a, and is injected from the plurality of first nozzles 29a. In addition, the second fuel HG that has flowed into the second header portion 36b flows into the plurality of second nozzles 29b via the plurality of second branch lines 38b that branch from the second header portion 36b, and is injected from the plurality of second nozzles 29b. In the co-combustion step S2, only the first fuel NG is supplied to the plurality of first nozzles 29a, and only the second fuel HG is supplied to the plurality of second nozzles 29b. Therefore, in the co-combustion step S2, the first fuel NG injected from the first nozzle 29a is burned, and the second fuel HG injected from the second nozzles 29b is burned. In this case, as described above, the number of the nozzles 29 that inject the second fuel HG is larger than the number of the nozzles 29 that inject the first fuel NG. In other words, the total cross-sectional area of the air flow channel frame 28 from which the second fuel HG is injected is larger than the total cross-sectional area of the air flow channel frame 28 from which the first fuel NG is injected.

As described above, since the total heat generation amount in the first-fuel-exclusive combustion step S1 and the total heat generation amount in the co-combustion step S2 are the same as each other, the total flow rate of the first fuel NG in the co-combustion step S2 in which the second fuel HG is supplied to the combustor 20 is smaller than the total flow rate of the first fuel NG in the first-fuel-exclusive combustion step S1 of not supplying the second fuel HG to the combustor 20. Therefore, the fuel-air ratio related to the first fuel NG in the co-combustion step S2 is lower than the fuel-air ratio related to the first fuel NG in the first-fuel-exclusive combustion step S1. As described above, the first fuel NG, which is the natural gas, has characteristics of poor combustibility when the fuel-air ratio is low. Therefore, in this step, in a case where only the first fuel NG is burned, the combustibility of the fuel in this step is deteriorated. However, in the co-combustion step S2, the hydrogen gas that is the second fuel HG injected from the second nozzles 29b is also burned during the combustion of the natural gas that is the first fuel NG injected from the first nozzle 29a. Therefore, the combustion of the hydrogen gas that is the second fuel HG injected from the second nozzles 29b complements the combustibility of the natural gas that is the first fuel NG, making it possible to suppress the deterioration in combustibility of the fuel.

In the second-fuel-exclusive combustion preparation step S3, the first fuel valve 33 is closed, the second fuel valve 34 is opened, and the first gate valve 37a is closed. As a result, the second fuel HG continues to flow into the second header portion 36b in the header line 36, while the first fuel NG does not flow into the header line 36. The second fuel HG that has flowed into the second header portion 36b flows into the plurality of second nozzles 29b via the plurality of second branch lines 38b that branch from the second header portion 36b, and is injected from the plurality of second nozzles 29b, as in the co-combustion step S2. Therefore, in the second-fuel-exclusive combustion preparation step S3, only the second fuel HG injected from the second nozzles 29b is burned.

In the second-fuel-exclusive combustion step S4, the first fuel valve 33 is closed, the second fuel valve 34 is opened, and the first gate valve 37a is opened. As a result, only the second fuel HG flows into the entire header line 36. The second fuel HG that has flowed into the header line 36 flows into the plurality of second nozzles 29b via the plurality of second branch lines 38b that branch from the second header portion 36b in the header line 36 and is injected from the plurality of second nozzles 29b, and also flows into the plurality of first nozzles 29a via the plurality of first branch lines 38a that branch from the first header portion 36a in the header line 36 and is injected from the plurality of first nozzles 29a. Therefore, in the second-fuel-exclusive combustion step S4, only the second fuel HG injected from the second nozzles 29b and the plurality of first nozzles 29a is burned.

As described above, in the present embodiment, even when the fuel-air ratio related to the natural gas, which is the first fuel NG, is lowered during the fuel switching process, the second fuel HG is also burned during the combustion of the first fuel NG, so that the combustibility of the natural gas, which is the first fuel NG, is compensated for, and the deterioration in combustibility of the fuel can be suppressed.

### Second Fuel Switching Step According to Present Embodiment

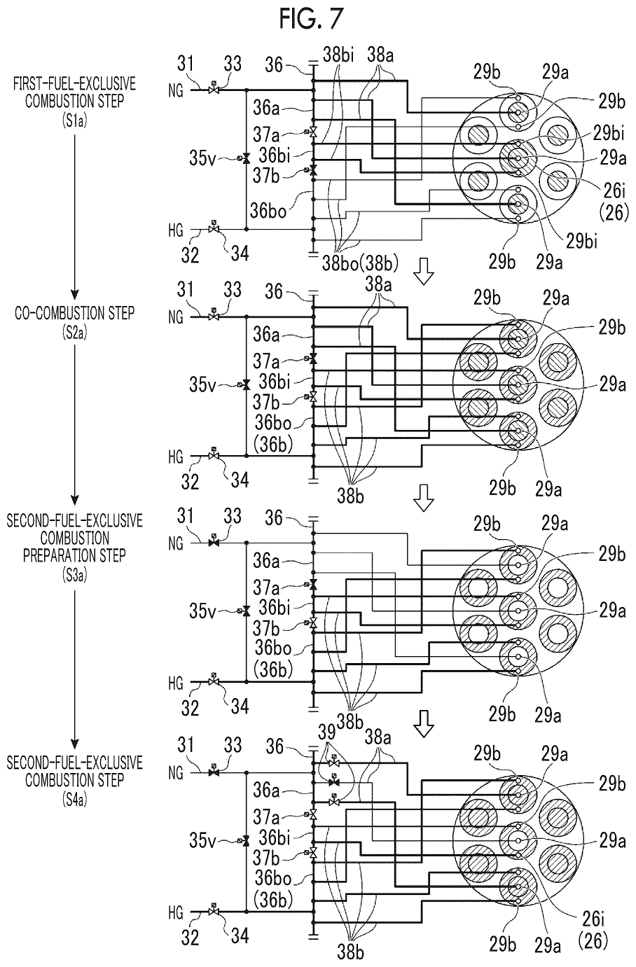

The second fuel switching step according to the present embodiment will be described with reference to FIG. 7. As in the first fuel switching step, the second fuel switching step is also a step of switching the fuel from the first fuel NG to the second fuel HG when the gas turbine output is low. However, the gas turbine output during the second fuel switching step is slightly higher than the gas turbine output during the first fuel switching step. As in the first fuel switching step, the second fuel switching step also includes a first-fuel-exclusive combustion step S1a, a co-combustion step S2a, a second-fuel-exclusive combustion preparation step S3a, and a second-fuel-exclusive combustion step S4a. In FIG. 7 as well, for simplification, some of the first nozzles 29a and some of the second nozzles 29b are omitted.

In the first-fuel-exclusive combustion step S1a, the first fuel valve 33 is opened, the second fuel valve 34 is closed, the first gate valve 37a is opened, the second gate valve 37b is closed, and the mixing ratio regulating valve 35v is closed. In the first fuel switching step, in the first-fuel-exclusive combustion step S1, the first gate valve 37a is closed and the second gate valve 37b is opened, but, in the first-fuel-exclusive combustion step S1s, the first gate valve 37a is opened and the second gate valve 37b is closed. As a result, the second fuel HG does not flow into the header line 36, and only the first fuel NG flows into the first header portion 36a and the first side second header portion 36bi in the header line 36. The first fuel NG that has flowed into the first header portion 36a flows into a plurality of first nozzles 29a via the plurality of first branch lines 38a that branch from the first header portion 36a, and is injected from the plurality of first nozzles 29a. In addition, the first fuel NG that has flowed into the first side second header portion 36bi flows into the first side second nozzles 29bi, which are the second nozzles 29b of the inner burner group 26i, among the second nozzles 29b via the plurality of first side second branch lines 38bi that branch from the first side second header portion 36bi.

In the first-fuel-exclusive combustion step S1a, only the first fuel NG is supplied to the plurality of first nozzles 29a and the first side second nozzles 29bi, and the first fuel NG and the second fuel HG are not supplied to the plurality of second side second nozzles 29bo. Therefore, in the first-fuel-exclusive combustion step S1a, only the first fuel NG injected from the first nozzle 29a and the first side second nozzles 29bi is burned.

In the co-combustion step S2a, as in the co-combustion step S2 of the first fuel switching step, the first fuel valve 33 is opened, the second fuel valve 34 is opened, the first gate valve 37a is closed, the second gate valve 37b is opened, and the mixing ratio regulating valve 35v is closed. As a result, the first fuel NG continues to flow into the first header portion 36a in the header line 36, and the second fuel HG flows into the second header portion 36b in the header line 36. The first fuel NG that has flowed into the first header portion 36a flows into a plurality of first nozzles 29a via the plurality of first branch lines 38a that branch from the first header portion 36a, and is injected from the plurality of first nozzles 29a. In addition, the second fuel HG that has flowed into the second header portion 36b flows into the plurality of second nozzles 29b via the plurality of second branch lines 38b that branch from the second header portion 36b, and is injected from the plurality of second nozzles 29b. In this case, the number of the nozzles 29 that inject the second fuel HG is larger than the number of the nozzles 29 that inject the first fuel NG. In other words, the total cross-sectional area of the air flow channel frame 28 from which the second fuel HG is injected is larger than the total cross-sectional area of the air flow channel frame 28 from which the first fuel NG is injected.

As described above, in the co-combustion step S2a, only the first fuel NG is supplied to the plurality of first nozzles 29a, and only the second fuel HG is supplied to the plurality of second nozzles 29b. Therefore, in the co-combustion step S2a, the first fuel NG injected from the first nozzle 29a is burned, and the second fuel HG injected from the second nozzles 29b is burned.

In the second-fuel-exclusive combustion preparation step S3a, as in the second-fuel-exclusive combustion preparation step S3 of the first fuel switching step, the first fuel valve 33 is closed, the second fuel valve 34 is opened, the first gate valve 37a is closed, the second gate valve 37b is opened, and the mixing ratio regulating valve 35v is closed. As a result, the second fuel HG continues to flow into the second header portion 36b in the header line 36, while the first fuel NG does not flow into the header line 36. The second fuel HG that has flowed into the second header portion 36b flows into the plurality of second nozzles 29b via the plurality of second branch lines 38b that branch from the second header portion 36b, and is injected from the plurality of second nozzles 29b, as in the co-combustion step S2a.

As described above, in the second-fuel-exclusive combustion preparation step S3a, the first fuel NG and the second fuel HG are not supplied to the plurality of first nozzles 29a, and only the second fuel HG is supplied to the plurality of second nozzles 29b. Therefore, in the second-fuel-exclusive combustion preparation step S3a, only the second fuel HG injected from the second nozzles 29b is burned.

In the second-fuel-exclusive combustion step S4a, as in the second-fuel-exclusive combustion step S4 of the first fuel switching step, the first fuel valve 33 is closed, the second fuel valve 34 is opened, the first gate valve 37a is opened, the second gate valve 37b is opened, and the mixing ratio regulating valve 35v is closed. As a result, only the second fuel HG flows into the entire header line 36. The second fuel HG that has flowed into the header line 36 flows into the plurality of second nozzles 29b via the plurality of second branch lines 38b that branch from the second header portion 36b in the header line 36 and is injected from the plurality of second nozzles 29b, and also flows into the plurality of first nozzles 29a via the plurality of first branch lines 38a that branch from the first header portion 36a in the header line 36 and is injected from the plurality of first nozzles 29a. However, in the second-fuel-exclusive combustion step S4a, as in the second-fuel-exclusive combustion step S4 of the first fuel switching step, the second fuel HG is not supplied to the first nozzle 29a included in the inner burner group 26i among the plurality of first nozzles 29a, due to a relationship with the total flow rate of the second fuel HG supplied to the combustor 20, However, in the second-fuel-exclusive combustion step S4a, as described with reference to FIG. 6, in accordance with the total flow rate of the second fuel HG supplied to the combustor 20, all the nozzle valves 39 provided in the plurality of first branch lines 38a may be opened, and the second fuel HG may be supplied to all the first nozzles 29a.

In the second-fuel-exclusive combustion step S4a, only the second fuel HG is supplied to all the nozzles 29 excluding the first nozzle 29a included in the inner burner group 26i among the plurality of nozzles 29. Therefore, in the second-fuel-exclusive combustion step S4a, only the second fuel HG injected from the second nozzles 29b and the second fuel HG injected from some of the first nozzles 29a are burned.

The fuel-air ratio related to the first fuel NG in the co-combustion step S2a of the second fuel switching step is lower than the fuel-air ratio related to the first fuel NG in the first-fuel-exclusive combustion step S1a, as in the fuel-air ratio related to the first fuel NG in the co-combustion step S2 of the first fuel switching step. However, in the co-combustion step S2a, the hydrogen gas that is the second fuel HG injected from the second nozzles 29b is also burned during the combustion of the natural gas that is the first fuel NG injected from the first nozzle 29a. Therefore, the combustion of the hydrogen gas that is the second fuel HG injected from the second nozzles 29b complements the combustibility of the natural gas that is the first fuel NG, making it possible to suppress the deterioration in combustibility of the fuel.

Therefore, in the second fuel switching step according to the present embodiment, as in the first fuel switching step, it is possible to suppress the deterioration in combustibility of the fuel during the fuel switching process.

In addition, the fuel supply system 30 according to the present embodiment has the first gate valve 37a and the second gate valve 37b as the valves that partition the header line 36, and thus it is possible to change the position at which the header line 36 is partitioned into two portions. Therefore, in the first-fuel-exclusive combustion step S1a of the second fuel switching step, the number of the nozzles 29 that inject the first fuel NG can be changed from the number of the nozzles 29 that inject the first fuel NG in the first-fuel-exclusive combustion step S1 of the first fuel switching step. Therefore, in the present embodiment, it is possible to flexibly respond to the change in output in the low output range in a case where the first fuel NG is exclusively burned.

### Third Fuel Switching Step According to Present Embodiment

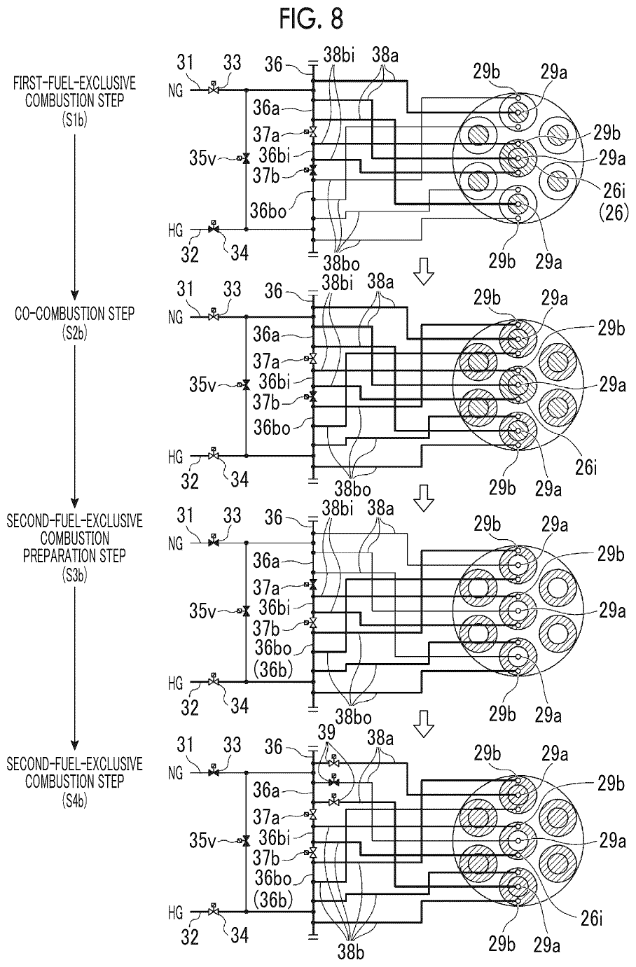

The third fuel switching step according to the present embodiment will be described with reference to FIG. 8. As in the second fuel switching step, the third fuel switching step is also a step of switching the fuel from the first fuel NG to the second fuel HG when the gas turbine output is low. As in the first fuel switching step and the second fuel switching step, the third fuel switching step also includes a first-fuel-exclusive combustion step S1b, a co-combustion step S2b, a second-fuel-exclusive combustion preparation step S3b, and a second-fuel-exclusive combustion step S4b. In FIG. 8 as well, for simplification, some of the first nozzles 29a and some of the second nozzles 29b are omitted.

In the first-fuel-exclusive combustion step S1b, as in the first-fuel-exclusive combustion step S1a of the second fuel switching step, the first fuel valve 33 is opened, the second fuel valve 34 is closed, the first gate valve 37a is opened, the second gate valve 37b is closed, and the mixing ratio regulating valve 35v is closed. As a result, the second fuel HG does not flow into the header line 36, and only the first fuel NG flows into the first header portion 36a and the first side second header portion 36bi in the header line 36. The first fuel NG that has flowed into the first header portion 36a flows into a plurality of first nozzles 29a via the plurality of first branch lines 38a that branch from the first header portion 36a, and is injected from the plurality of first nozzles 29a. In addition, the first fuel NG that has flowed into the first side second header portion 36bi flows into the first side second nozzles 29bi, which are the second nozzles 29b of the inner burner group 26i, among the second nozzles 29b via the plurality of first side second branch lines 38bi that branch from the first side second header portion 36bi. Therefore, in the first-fuel-exclusive combustion step S1b, only the first fuel NG injected from the first nozzle 29a and the first side second nozzles 29bi is burned.

In the co-combustion step S2b, the first fuel valve 33 is opened, the second fuel valve 34 is opened, the first gate valve 37a is opened, the second gate valve 37b is closed, and the mixing ratio regulating valve 35v is closed. In the co-combustion step S2 of the first fuel switching step and the co-combustion step S2a of the second fuel switching step, the first gate valve 37a is closed and the second gate valve 37b is opened, but, in the co-combustion step S2b, the first gate valve 37a is opened and the second gate valve 37b is closed. As a result, the first fuel NG continues to flow into the first header portion 36a and the first side second header portion 36bi in the header line 36. The first fuel NG that has flowed into the first header portion 36a flows into a plurality of first nozzles 29a via the plurality of first branch lines 38a that branch from the first header portion 36a, and is injected from the plurality of first nozzles 29a. In addition, the first fuel NG that has flowed into the first side second header portion 36bi flows into the first side second nozzles 29bi, which are the second nozzles 29b of the inner burner group 26i, among the second nozzles 29b via the plurality of first side second branch lines 38bi that branch from the first side second header portion 36bi. Further, the second fuel HG flows into the second side second header portion 36bo in the header line 36. The second fuel HG that has flowed into the second side second header portion 36bo flows into the second side second nozzles 29bo, which are the second nozzles 29b included in the plurality of outer burner groups 26o among the second nozzles 29b, via the plurality of second side second branch lines 38bo that branch from the second side second header portion 36bo. In the co-combustion step S2b, the first fuel NG injected from the plurality of first nozzles 29a and the first side second nozzles 29bi is burned, and the second fuel HG injected from the plurality of second side second nozzles 29bo is burned. In this case, the number of the nozzles 29 that inject the second fuel HG is larger than the number of the nozzles 29 that inject the first fuel NG. In other words, the total cross-sectional area of the air flow channel frame 28 from which the second fuel HG is injected is larger than the total cross-sectional area of the air flow channel frame 28 from which the first fuel NG is injected.

In the second-fuel-exclusive combustion preparation step S3b, as in the second-fuel-exclusive combustion preparation step S3 of the first fuel switching step and the second-fuel-exclusive combustion preparation step S3a of the second fuel switching step, the first fuel valve 33 is closed, the second fuel valve 34 is opened, the first gate valve 37a is closed, the second gate valve 37b is opened, and the mixing ratio regulating valve 35v is closed. As a result, the second fuel HG flows into the entire second header portion 36b in the header line 36, and the first fuel NG does not flow into the header line 36. The second fuel HG that has flowed into the second header portion 36b flows into the plurality of second nozzles 29b via the plurality of second branch lines 38b that branch from the second header portion 36b, and is injected from the plurality of second nozzles 29b. In the second-fuel-exclusive combustion preparation step S3b, the first fuel NG and the second fuel HG are not supplied to the plurality of first nozzles 29a. and only the second fuel HG is supplied to the plurality of second nozzles 29b. Therefore, in the second-fuel-exclusive combustion preparation step S3b, only the second fuel HG injected from the second nozzles 29b is burned.

In the second-fuel-exclusive combustion step S4b, as in the second-fuel-exclusive combustion step S4 of the first fuel switching step and the second-fuel-exclusive combustion step S4a of the second fuel switching step, the first fuel valve 33 is closed, the second fuel valve 34 is opened, the first gate valve 37a is opened, the second gate valve 37b is opened, and the mixing ratio regulating valve 35v is closed. As a result, only the second fuel HG flows into the entire header line 36. The second fuel HG that has flowed into the header line 36 flows into the plurality of second nozzles 29b via the plurality of second branch lines 38b that branch from the second header portion 36b in the header line 36 and is injected from the plurality of second nozzles 29b, and flows into the plurality of first nozzles 29a via the plurality of first branch lines 38a that branch from the first header portion 36a in the header line 36 and is injected from the plurality of first nozzles 29a. However, in the second-fuel-exclusive combustion step S4b, as in the second-fuel-exclusive combustion step S4 of the first fuel switching step and the second-fuel-exclusive combustion step S4a of the second fuel switching step, the second fuel HG is not supplied to the first nozzle 29a included in the inner burner group 26i among the plurality of first nozzles 29a, due to the relationship with the total flow rate of the second fuel HG supplied to the combustor 20. In the second-fuel-exclusive combustion step S4b, only the second fuel HG injected from the second nozzles 29b and the second fuel HG injected from some of the first nozzles 29a are burned. However, in the second-fuel-exclusive combustion step S4b, as described with reference to FIG. 6, in accordance with the total flow rate of the second fuel HG supplied to the combustor 20, all the nozzle valves 39 provided in the plurality of first branch lines 38a may be opened, and the second fuel HG may be supplied to all the first nozzles 29a.

The fuel-air ratio related to the first fuel NG in the co-combustion step S2b of the third fuel switching step is lower than the fuel-air ratio related to the first fuel NG in the first-fuel-exclusive combustion step S1b, as in the fuel-air ratio related to the first fuel NG in the co-combustion step S2 of the first fuel switching step and the co-combustion step S2a of the second fuel switching step.

However, in the co-combustion step S2b, the hydrogen gas that is the second fuel HG injected from the second nozzles 29b is also burned during the combustion of the natural gas that is the first fuel NG injected from the first nozzle 29a. Therefore, the combustion of the hydrogen gas that is the second fuel HG injected from the second nozzles 29b complements the combustibility of the natural gas that is the first fuel NG, making it possible to suppress the deterioration in combustibility of the fuel.

Therefore, in the third fuel switching step according to the present embodiment, it is possible to suppress the deterioration in combustibility of the fuel during the fuel switching process, as in the first fuel switching step.

In addition, the fuel supply system 30 according to the present embodiment has the first gate valve 37a and the second gate valve 37b as the valves that partition the header line 36, and thus it is possible to change the position at which the header line 36 is partitioned into two portions. Therefore, in the co-combustion step S2a of the third fuel switching step, the number of the nozzles 29 that inject the first fuel NG can be changed with respect to the number of the nozzles 29 that inject the first fuel NG in the co-combustion step S2b of the second fuel switching step. Therefore, in the present embodiment, in the co-combustion step S2b, an amount of influence of the combustion of the second fuel HG on the combustibility of the first fuel NG can be changed.

### Fourth Fuel Switching Step According to Present Embodiment

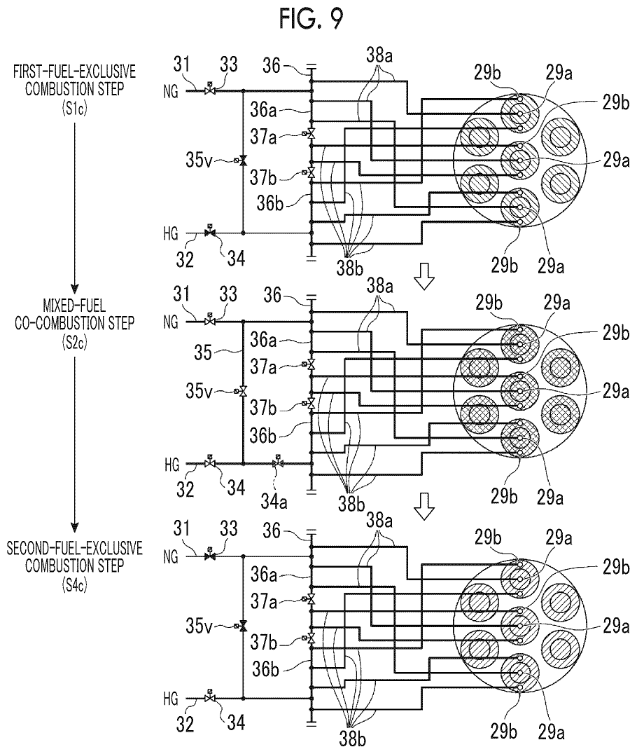

The fourth fuel switching step according to the present embodiment will be described with reference to FIG. 9. The fourth fuel switching step is a step of switching the fuel from the first fuel NG to the second fuel HG when the gas turbine output is high. The fourth fuel switching step includes a first-fuel-exclusive combustion step S1c, a mixed-fuel co-combustion step S2c, and a second-fuel-exclusive combustion step S4c. In FIG. 9 as well, for simplification, some of the first nozzles 29a and some of the second nozzles 29b are omitted. Further, the high output here is, for example, 50% or more of the rated output of the gas turbine. However, the percentage is changed depending on the gas turbine. That is, in some gas turbines, the high output may be, for example, 75% or more of the rated output of the gas turbine.

In the first-fuel-exclusive combustion step S1c, the first fuel valve 33 is opened, the second fuel valve 34 is closed, the first gate valve 37a is opened, the second gate valve 37b is opened, and the mixing ratio regulating valve 35v is closed. As a result, the second fuel HG does not flow into the header line 36, and only the first fuel NG flows into the header line 36. The first fuel NG that has flowed into the first header portion 36a in the header line 36 flows into a plurality of first nozzles 29a via the plurality of first branch lines 38a that branch from the first header portion 36a, and is injected from the plurality of first nozzles 29a. In addition, the first fuel NG that has flowed into the second header portion 36b in the header line 36 flows into the second nozzles 29b via the plurality of second branch lines 38b that branch from the second header portion 36b.

In the first-fuel-exclusive combustion step S1c, only the first fuel NG is supplied to all the nozzles 29. Therefore, in the first-fuel-exclusive combustion step S1c, only the first fuel NG injected from all the nozzles 29 is burned.

In the mixed-fuel co-combustion step S2c, the first fuel valve 33 is opened, the second fuel valve 34 is opened, the first gate valve 37a is opened, the second gate valve 37b is opened, and the mixing ratio regulating valve 35v is opened. In a case where a supply pressure of the second fuel HG from the second fuel supply source is higher than a supply pressure of the first fuel NG from the first fuel supply source, the second fuel HG flows into the first fuel line 31 from the second fuel line 32 via the connection line 35 and the mixing ratio regulating valve 35v, and is mixed with the first fuel NG therein to become the mixed fuel. The mixed fuel flows into the header line 36.

The mixed fuel that has flowed into the first header portion 36a in the header line 36 flows into a plurality of first nozzles 29a via the plurality of first branch lines 38a that branch from the first header portion 36a, and is injected from the plurality of first nozzles 29a. In addition, the mixed fuel that has flowed into the second header portion 36b in the header line 36 flows into the second nozzles 29b via the plurality of second branch lines 38b that branch from the second header portion 36b.

In the mixed-fuel co-combustion step S2c, the mixed fuel is supplied to all the nozzles 29.

Therefore, in the mixed-fuel co-combustion step S2c, the mixed fuel injected from all the nozzles 29 is burned.

As described above, in a case where the supply pressure of the second fuel HG from the second fuel supply source is higher than the supply pressure of the first fuel NG from the first fuel supply source, a portion of the second fuel HG flows into the first fuel line 31 from the second fuel line 32 via the connection line 35 and the mixing ratio regulating valve 35v, and is mixed with the first fuel NG therein to become the mixed fuel. However, another portion of the second fuel HG may flow directly from the second fuel line 32 into the header line 36. Therefore, it is preferable to provide a downstream second fuel valve 34a in the second fuel line 32 at a position between a connection position with the connection line 35 and a connection position with the header line 36. In the mixed-fuel co-combustion step S2c, the downstream second fuel valve 34a is closed, so that a portion of the second fuel HG is prevented from flowing directly from the second fuel line 32 into the header line 36.

In the second-fuel-exclusive combustion step S4c, the first fuel valve 33 is closed, the second fuel valve 34 is opened, the first gate valve 37a is opened, the second gate valve 37b is opened, and the mixing ratio regulating valve 35v is closed. As a result, the first fuel NG does not flow into the header line 36, and only the second fuel HG flows into the header line 36. The second fuel HG that has flowed into the first header portion 36a in the header line 36 flows into a plurality of first nozzles 29a via the plurality of first branch lines 38a that branch from the first header portion 36a, and is injected from the plurality of first nozzles 29a. In addition, the second fuel HG that has flowed into the second header portion 36b in the header line 36 flows into the second nozzles 29b via the plurality of second branch lines 38b that branch from the second header portion 36b.

In the second-fuel-exclusive combustion step S4c, only the second fuel HG is supplied to all the nozzles 29. Therefore, in the second-fuel-exclusive combustion step S4c, only the second fuel HG injected from all the nozzles 29 is burned.

In the present embodiment, the first fuel NG can be supplied to all the nozzles 29, and the second fuel HG can be supplied to all the nozzles 29. Therefore, in the present embodiment, unlike the above-described second comparative example, the gas turbine output corresponding to the total number of the nozzles 29 can be obtained by executing the exclusive combustion of one of the first fuel NG and the second fuel HG.

### Summary of Effects in Present Embodiment

In the present embodiment, even when one fuel of two types of fuel is inferior to the other fuel in fuel characteristics, the deficiency can be compensated for by the combustion of the other fuel, and thus the stable fuel combustion is enabled even during the fuel switching process.

In the present embodiment, the gas turbine output corresponding to the total number of the nozzles 29 can be obtained by executing the exclusive combustion of one of the first fuel NG and the second fuel HG.

In the present embodiment, as the fuel switching step, the first fuel switching step, the second fuel switching step, the third fuel switching step, and the fourth fuel switching step can be executed, and thus the fuel switching mode can be changed as appropriate.

Further, the fuel supply system 30 according to the present embodiment has the first gate valve 37a and the second gate valve 37b as the valves that partition the header line 36, and thus it is possible to change the position at which the header line 36 is partitioned into two portions. Therefore, the number of the nozzles 29 that inject the first fuel NG and the number of the nozzles 29 that inject the second fuel HG can be changed as appropriate.

### Modification Example

The first fuel NG in the above-described embodiment is the natural gas, and the second fuel HG is the hydrogen gas. However, the combination of the two types of fuel is not limited to the combination described in the present embodiment. For example, one of the two types of fuel may be the natural gas, and the other may be any one of ammonia gas, coke oven gas (COG), propane gas, and coal gasification gas.

In addition, the present disclosure is not limited to the above-described embodiment and the modification example. Various additions, modifications, substitutions, partial deletions, and the like can be made without departing from the conceptual idea and scope of the present invention derived from the contents defined in the claims and equivalents thereof.

### Supplementary Notes

The operation method of a gas turbine according to the above-described embodiment is understood, for example, as follows.
(1) A first aspect relates to an operation method of a gas turbine applied to the following gas turbine.

The gas turbine includes a compressor 10 capable of compressing air to generate compressed air Acom, a combustor 20 capable of burning fuel in the compressed air Acom to generate combustion gas, and a turbine 15 capable of being driven by the combustion gas. The combustor 20 includes a cylinder 25 in which the fuel is capable of being burned, and a plurality of burners 27 capable of injecting the fuel into the cylinder 25 together with the compressed air Acom. The plurality of burners 27 include a first burner 27a and a plurality of second burners 27b excluding the first burner 27a. The first burner 27a and the plurality of second burners 27b each include an air flow channel frame 28 capable of allowing the air to flow and capable of injecting the air into the cylinder 25, and a nozzle 29 capable of injecting the fuel into the air flow channel frame 28.

The operation method of a gas turbine 1 includes executing a fuel switching step of switching the fuel to be supplied to the combustor 20 from a first fuel NG to a second fuel HG.

The fuel switching step includes a first-fuel-exclusive combustion step S1 of supplying only the first fuel NG to a first nozzle 29a that is the nozzle 29 of the first burner 27a, and not supplying the first fuel NG and the second fuel HG to second nozzles 29b that are the respective nozzles 29 of the plurality of second burners 27b, a co-combustion step S2 of supplying only the first fuel NG to the first nozzle 29a and supplying only the second fuel HG to the second nozzles 29b after the first-fuel-exclusive combustion step S1, a second-fuel-exclusive combustion preparation step S3 of not supplying the first fuel NG and the second fuel HG to the first nozzle 29a and supplying the second fuel HG only to the second nozzles 29b after the co-combustion step S2, and a second-fuel-exclusive combustion step S4 of supplying only the second fuel HG to the first nozzle 29a and the second nozzles 29b after the second-fuel-exclusive combustion preparation step S3.

In the present aspect, even when one fuel of two types of fuel is inferior to the other fuel in fuel characteristics, the deficiency can be compensated for by the combustion of the other fuel, and thus the stable fuel combustion is enabled even during the fuel switching process.
(2) A second aspect relates to the operation method of a gas turbine 1 according to the first aspect, further including: executing a second fuel switching step in addition to a first fuel switching step that is the fuel switching step.

The second fuel switching step includes a first-fuel-exclusive combustion step S1a of supplying only the first fuel NG to first side second nozzles 29bi that are some of the respective second nozzles 29b of the plurality of second burners 27b, and to the first nozzle 29a, and not supplying the first fuel NG and the second fuel HG to a plurality of second side second nozzles 29bo excluding the first side second nozzles 29bi among the respective second nozzles 29b of the plurality of second burners 27b, a co-combustion step S2a of supplying only the first fuel NG to the first nozzle 29a and supplying only the second fuel HG to the second nozzles 29b after the first-fuel-exclusive combustion step S1a, a second-fuel-exclusive combustion preparation step S3a of not supplying the first fuel NG and the second fuel HG to the first nozzle 29a and supplying the second fuel HG only to the second side second nozzles 29bo after the co-combustion step S2a, and a second-fuel-exclusive combustion step S4a of supplying only the second fuel HG to the first nozzle 29a and the second side second nozzles 29bo after the second-fuel-exclusive combustion preparation step S3a.

In the present aspect, in addition to the first fuel switching step, the second fuel switching step can also be executed, and the fuel switching mode can be changed as appropriate.
(3) A third aspect relates to the operation method of a gas turbine 1 according to the first or second aspect, further including: executing a third fuel switching step in addition to a first fuel switching step that is the fuel switching step.

The third fuel switching step includes a first-fuel-exclusive combustion step S1b of supplying only the first fuel NG to first side second nozzles 29bi that are some of the respective second nozzles 29b of the plurality of second burners 27b, and to the first nozzle 29a, and not supplying the first fuel NG and the second fuel HG to a plurality of second side second nozzles 29bo excluding the first side second nozzles 29bi among the respective second nozzles 29b of the plurality of second burners 27b, a co-combustion step S2b of supplying only the first fuel NG to the first nozzle 29a and the first side second nozzles 29bi and supplying only the second fuel HG to the second side second nozzles 29bo after the first-fuel-exclusive combustion step S1b, a second-fuel-exclusive combustion preparation step S3b of not supplying the first fuel NG and the second fuel HG to the first nozzle 29a and supplying the second fuel HG only to the second side second nozzles 29bo after the co-combustion step S2b, and a second-fuel-exclusive combustion step S4b of supplying only the second fuel HG to the first nozzle 29a and the second side second nozzles 29bo after the second-fuel-exclusive combustion preparation step S3b.

In the present aspect, in addition to the first fuel switching step, the third fuel switching step can also be executed, and the fuel switching mode can be changed as appropriate.
(4) A fourth aspect relates to the operation method of a gas turbine I according to any one of the first to third aspects, further including: executing a fourth fuel switching step in addition to a first fuel switching step that is the fuel switching step.

The fourth fuel switching step includes a first-fuel-exclusive combustion step Sic of supplying only the first fuel NG to the first nozzle 29a and the second nozzles 29b, a mixed-fuel co-combustion step S2c of supplying a mixed fuel in which the first fuel NG and the second fuel HG are mixed, to the first nozzle 29a and the second nozzles 29b after the first-fuel-exclusive combustion step S1c, and a second-fuel-exclusive combustion step S4c of supplying only the second fuel HG to the first nozzle 29a and the second nozzles 29b after the mixed-fuel co-combustion step S2c.

In the present aspect, in addition to the first fuel switching step, the fourth fuel switching step can also be executed, and the fuel switching mode can be changed as appropriate.
(5) A fifth aspect relates to the operation method of a gas turbine 1 according to any one of the first to fourth aspects, in which the combustor 20 includes a plurality of burner groups 26.

The plurality of burner groups 26 each include the first nozzle 29a and the second nozzles 29b disposed around the first nozzle 29a. The first fuel NG is natural gas, and the second fuel HG is hydrogen gas.
(6) A sixth aspect relates to the operation method of a gas turbine 1 according to the second or third aspect, in which the combustor 20 includes a plurality of burner groups 26.

The plurality of burner groups 26 include an inner burner group 26i and a plurality of outer burner groups 26o disposed around the inner burner group 26i. The plurality of burner groups 26 each include the first nozzle 29a and the second nozzles 29b disposed around the first nozzle 29a. The first side second nozzles 29bi are the second nozzles 29b included in the inner burner group 26i. The plurality of second side second nozzles 29bo are the second nozzles 29b included in each of the plurality of outer burner groups 26o. The first fuel NG is natural gas, and the second fuel HG is hydrogen gas.

The gas turbine equipment according to the above-described embodiment is understood, for example, as follows.
(7) A seventh aspect relates to gas turbine equipment including: a compressor 10 capable of compressing air to generate compressed air Acom; a combustor 20 capable of burning fuel in the compressed air Acom to generate combustion gas; a turbine 15 capable of being driven by the combustion gas; and a fuel supply system 30 capable of supplying a first fuel NG and a second fuel HG to the combustor 20.

The combustor 20 includes a cylinder 25 in which the fuel is capable of being burned, and a plurality of burners 27 capable of injecting the fuel into the cylinder 25 together with the compressed air Acom. The plurality of burners 27 include a first burner 27a and a plurality of second burners 27b excluding the first burner 27a. The first burner 27a and the plurality of second burners 27b each include an air flow channel frame 28 capable of allowing the air to flow and capable of injecting the air into the cylinder 25, and a nozzle 29 capable of injecting the fuel into the air flow channel frame 28. The fuel supply system 30 includes a first fuel line 31 connected to a supply source of the first fuel NG and through which the first fuel NG is capable of flowing, a second fuel line 32 connected to a supply source of the second fuel HG and through which the second fuel HG is capable of flowing, a first fuel valve 33 provided in the first fuel line 31, a second fuel valve 34 provided in the second fuel line 32, a header line 36 through which the first fuel NG and the second fuel HG are capable of flowing, branch lines 38 that branch from the header line 36 for each of the plurality of burners 27, and a gate valve 37a provided in the header line 36 and capable of partitioning the header line 36 into a first header portion 36a and a second header portion 36b. First branch lines 38a that are some of the respective branch lines 38 of the plurality of burners 27 branch from the first header portion 36a. The first branch lines 38a are connected to a first nozzle 29a that is the nozzle 29 of the first burner 27a. A plurality of second branch lines 38b excluding the first branch lines 38a among the respective branch lines 38 of the plurality of burners 27 branch from the second header portion 36b. Each of the plurality of second branch lines 38b is connected to a second nozzle 29b that is the nozzle 29 of each of the plurality of second burners 27b. The first fuel line 31 is connected to the first header portion 36a, and the second fuel line 32 is connected to the second header portion 36b.

In the present aspect, the first fuel NG is injected from the first nozzle 29a, and while the first fuel NG is being burned, the second fuel HG is injected from the second nozzles 29b, and thus the second fuel HG can be burned, Therefore, in the present aspect, even when one fuel of two types of fuel is inferior to the other fuel in fuel characteristics, the deficiency can be compensated for by the combustion of the other fuel, and thus the stable fuel combustion is enabled even during the fuel switching process.
(8) An eighth aspect relates to the gas turbine equipment according to the seventh aspect, further including: a second gate valve 37b provided in the second header portion 36b and capable of partitioning the second header portion 36b into a first side second header portion 36bi on a side of the first header portion 36a and a second side second header portion 36bo that is a remaining portion of the second header portion 36b, in addition to a first gate valve that is the gate valve 37a.

First side second branch lines 38bi that are some of the plurality of second branch lines 38b branch from the first side second header portion 36bi, First side second nozzles 29bi that are some of the respective second nozzles 29b of the plurality of second burners 27b are connected to the first side second branch lines 38bi. A plurality of second side second branch lines 38bo that are the second branch lines 38b excluding the first side second branch lines 38bi among the plurality of second branch lines 38b branch from the second side second header portion 36bo. Second side second nozzles 29bo that are the second nozzles 29b excluding the first side second nozzles 29bi among the respective second nozzles 29b of the plurality of second burners 27b are connected to the second side second branch lines 38bo. The second fuel line 32 is connected to the second side second header portion 36bo.

The gas turbine equipment of the present aspect includes the first gate valve 37a and the second gate valve 37b as the valves that partition the header line 36. Therefore, the flow channel in the header line 36 can be partitioned at two positions. Therefore, the number of the nozzles 29 into which the first fuel NG flows from the header line 36 and the number of the nozzles 29 into which the second fuel HG flows from the header line 36 can be changed as appropriate. Therefore, in the present aspect, the fuel switching mode can be changed as appropriate.
(9) A ninth aspect relates to the gas turbine equipment according to the seventh or eighth aspect, further including: a connection line 35 that connects a position in the first fuel line 31 between a position at which the first fuel line 31 is connected to the header line 36 and a position at which the first fuel valve 33 is provided, and a position in the second fuel line 32 between a position at which the second fuel line 32 is connected to the header line 36 and a position at which the second fuel valve 34 is provided; and a mixing ratio regulating valve 35v provided in the connection line 35 and capable of regulating a flow rate of the fuel that flows through the connection line 35.

In the present aspect, since the first fuel line 31 and the second fuel line 32 are connected to each other by the connection line 35, the mixed fuel in which the first fuel NG and the second fuel HG are mixed can flow into the header line 36. Therefore, in the present aspect, the mixed fuel can be burned by injecting the mixed fuel from the nozzle 29. Further, in the present aspect, the first fuel NG can be injected from all the nozzles 29 by causing the first fuel NG to flow into the entire header line 36, and the second fuel HG can be injected from all the nozzles 29 by causing the second fuel HG to flow into the entire header line 36. In addition, in the present aspect, the mixed fuel can be injected from all the nozzles 29 by causing the mixed fuel to flow into the entire header line 36.
(10) A tenth aspect relates to the gas turbine equipment according to any one of the seventh to ninth aspects, further including: a control device 50.

The control device 50 is capable of executing a fuel switching step of switching the fuel to be supplied to the combustor 20 from the first fuel NG to the second fuel HG by controlling the first fuel valve 33, the second fuel valve 34, and the gate valve 37a. The fuel switching step includes a first-fuel-exclusive combustion step S1 of supplying only the first fuel NG to the first nozzle 29a and not supplying the first fuel NG and the second fuel HG to the second nozzles 29b by opening the first fuel valve 33, closing the second fuel valve 34, and closing the gate valve, a co-combustion step S2 of supplying only the first fuel NG to the first nozzle 29a and supplying only the second fuel HG to the second nozzles 29b by opening the first fuel valve 33, opening the second fuel valve 34, and closing the gate valve after the first-fuel-exclusive combustion step S1, a second-fuel-exclusive combustion preparation step S3 of not supplying the first fuel NG and the second fuel HG to the first nozzle 29a and supplying the second fuel HG only to the second nozzles 29b by closing the first fuel valve 33, opening the second fuel valve 34, and closing the gate valve after the co-combustion step S2, and a second-fuel-exclusive combustion step S4 of supplying only the second fuel HG to the first nozzle 29a and the second nozzles 29b by closing the first fuel valve 33, opening the second fuel valve 34, and opening the gate valve after the second-fuel-exclusive combustion preparation step S3.

In the present aspect, the operation method according to the first aspect can be executed. Therefore, in the present aspect, as in the operation method according to the first aspect, the stable fuel combustion is enabled during the fuel switching process.
(11) An eleventh aspect relates to the gas turbine equipment according to the eighth aspect, further including: a control device 50.

The control device 50 is capable of executing first and second fuel switching steps of switching the fuel to be supplied to the combustor 20 from the first fuel NG to the second fuel HG by controlling the first fuel valve 33, the second fuel valve 34, the first gate valve 37a, and the second gate valve 37b.

The first fuel switching step includes a first-fuel-exclusive combustion step S1 of supplying only the first fuel NG to the first nozzle 29a and not supplying the first fuel NG and the second fuel HG to the second nozzles 29b by opening the first fuel valve 33, closing the second fuel valve 34, closing the first gate valve 37a, and opening the second gate valve 37b, a co-combustion step S2 of supplying only the first fuel NG to the first nozzle 29a and supplying only the second fuel HG to the second nozzles 29b by opening the first fuel valve 33, opening the second fuel valve 34, closing the first gate valve 37a, and opening the second gate valve 37b after the first-fuel-exclusive combustion step S1, a second-fuel-exclusive combustion preparation step S3 of not supplying the first fuel NG and the second fuel HG to the first nozzle 29a and supplying the second fuel HG only to the second nozzles 29b by closing the first fuel valve 33, opening the second fuel valve 34, closing the first gate valve 37a, and opening the second gate valve 37b after the co-combustion step S2, and a second-fuel-exclusive combustion step S4 of supplying only the second fuel HG to the first nozzle 29a and the second nozzles 29b by closing the first fuel valve 33, opening the second fuel valve 34, opening the first gate valve 37a, and opening the second gate valve 37b after the second-fuel-exclusive combustion preparation step S3.

The second fuel switching step includes a first-fuel-exclusive combustion step S1a of supplying only the first fuel NG to the first nozzle 29a and the first side second nozzles 29bi and not supplying the first fuel NG and the second fuel HG to the second side second nozzles 29bo by opening the first fuel valve 33, closing the second fuel valve 34, opening the first gate valve 37a, and closing the second gate valve 37b, a co-combustion step S2a of supplying only the first fuel NG to the first nozzle 29a and supplying only the second fuel HG to the second nozzles 29b by opening the first fuel valve 33, opening the second fuel valve 34, closing the first gate valve 37a, and opening the second gate valve 37b after the first-fuel-exclusive combustion step S1a, a second-fuel-exclusive combustion preparation step S3a of not supplying the first fuel NG and the second fuel HG to the first nozzle 29a and supplying the second fuel HG only to the second nozzles 29b by closing the first fuel valve 33, opening the second fuel valve 34, closing the first gate valve 37a, and opening the second gate valve 37b after the co-combustion step S2a, and a second-fuel-exclusive combustion step S4a of supplying only the second fuel HG to the first nozzle 29a and the second nozzles 29b by closing the first fuel valve 33, opening the second fuel valve 34, opening the first gate valve 37a, and opening the second gate valve 37b after the second-fuel-exclusive combustion preparation step S3a.

In the present aspect, as in the operation method according to the second aspect, in addition to the first fuel switching step, the second fuel switching step can also be executed, and the fuel switching mode can be changed as appropriate.
(12) A twelfth aspect relates to the gas turbine equipment according to the tenth or eleventh aspect, further including: a control device 50.

The control device 50 is capable of executing first and third fuel switching steps of switching the fuel to be supplied to the combustor 20 from the first fuel NG to the second fuel HG by controlling the first fuel valve 33, the second fuel valve 34, the first gate valve 37a, and the second gate valve 37b.

The first fuel switching step includes a first-fuel-exclusive combustion step S1 of supplying only the first fuel NG to the first nozzle 29a and not supplying the first fuel NG and the second fuel HG to the second nozzles 29b by opening the first fuel valve 33, closing the second fuel valve 34, closing the first gate valve 37a, and opening the second gate valve 37b, a co-combustion step S2 of supplying only the first fuel NG to the first nozzle 29a and supplying only the second fuel HG to the second nozzles 29b by opening the first fuel valve 33, opening the second fuel valve 34, closing the first gate valve 37a, and opening the second gate valve 37b after the first-fuel-exclusive combustion step S1, a second-fuel-exclusive combustion preparation step S3 of not supplying the first fuel NG and the second fuel HG to the first nozzle 29a and supplying the second fuel HG only to the second nozzles 29b by closing the first fuel valve 33, opening the second fuel valve 34, closing the first gate valve 37a, and opening the second gate valve 37b after the co-combustion step S2, and a second-fuel-exclusive combustion step S4 of supplying only the second fuel HG to the first nozzle 29a and the second nozzles 29b by closing the first fuel valve 33, opening the second fuel valve 34, opening the first gate valve 37a, and opening the second gate valve 37b after the second-fuel-exclusive combustion preparation step S3.

The third fuel switching step includes a first-fuel-exclusive combustion step S1b of supplying only the first fuel NG to the first nozzle 29a and the first side second nozzles 29bi and not supplying the first fuel NG and the second fuel HG to the second side second nozzles 29bo by opening the first fuel valve 33, closing the second fuel valve 34, opening the first gate valve 37a, and closing the second gate valve 37b, a co-combustion step S2b of supplying only the first fuel NG to the first nozzle 29a and the first side second nozzles 29bi and supplying only the second fuel HG to the second side second nozzles 29bo by opening the first fuel valve 33, opening the second fuel valve 34, closing the first gate valve 37a, and opening the second gate valve 37b after the first-fuel-exclusive combustion step S1b, a second-fuel-exclusive combustion preparation step S3b of not supplying the first fuel NG and the second fuel HG to the first nozzle 29a and supplying the second fuel HG only to the second nozzles 29b by closing the first fuel valve 33, opening the second fuel valve 34, opening the first gate valve 37a, and closing the second gate valve 37b after the co-combustion step S2b, and a second-fuel-exclusive combustion step S4b of supplying only the second fuel HG to the first nozzle 29a and the second nozzles 29b by closing the first fuel valve 33, opening the second fuel valve 34, opening the first gate valve 37a, and opening the second gate valve 37b after the second-fuel-exclusive combustion preparation step S3b.

In the present aspect, as in the operation method according to the third aspect, in addition to the first fuel switching step, the third fuel switching step can also be executed, and the fuel switching mode can be changed as appropriate.
(13) A thirteenth aspect relates to the gas turbine equipment according to the ninth aspect, further including: a control device 50.

The control device 50 is capable of executing first and fourth fuel switching steps of switching the fuel to be supplied to the combustor 20 from the first fuel NG to the second fuel HG by controlling the first fuel valve 33, the second fuel valve 34, the gate valve 37a, and the mixing ratio regulating valve 35v.

The first fuel switching step includes a first-fuel-exclusive combustion step S1 of supplying only the first fuel NG to the first nozzle 29a and not supplying the first fuel NG and the second fuel HG to the second nozzles 29b by opening the first fuel valve 33, closing the second fuel valve 34, closing the gate valve 37a, and closing the mixing ratio regulating valve 35v, a co-combustion step S2 of supplying only the first fuel NG to the first nozzle 29a and supplying only the second fuel HG to the second nozzles 29b by opening the first fuel valve 33, opening the second fuel valve 34, closing the gate valve 37a, and closing the mixing ratio regulating valve 35v after the first-fuel-exclusive combustion step S1, a second-fuel-exclusive combustion preparation step S3 of not supplying the first fuel NG and the second fuel HG to the first nozzle 29a and supplying the second fuel HG only to the second nozzles 29b by closing the first fuel valve 33, opening the second fuel valve 34, closing the gate valve 37a, and closing the mixing ratio regulating valve 35v after the co-combustion step S2, and a second-fuel-exclusive combustion step S4 of supplying only the second fuel HG to the first nozzle 29a and the second nozzles 29b by closing the first fuel valve 33, opening the second fuel valve 34, opening the gate valve 37a, and closing the mixing ratio regulating valve 35v after the second-fuel-exclusive combustion preparation step S3.

The fourth fuel switching step includes a first-fuel-exclusive combustion step S1c of supplying only the first fuel NG to the first nozzle 29a and the second nozzles 29b by opening the first fuel valve 33, closing the second fuel valve 34, opening the gate valve, and closing the mixing ratio regulating valve 35v, a mixed-fuel co-combustion step S2c of supplying a mixed fuel in which the first fuel NG and the second fuel HG are mixed, to the first nozzle 29a and the second nozzles 29b by opening the first fuel valve 33, opening the second fuel valve 34, opening the gate valve, and closing the mixing ratio regulating valve 35v after the first-fuel-exclusive combustion step S1c, and a second-fuel-exclusive combustion step S4c of supplying only the second fuel HG to the first nozzle 29a and the second nozzles 29b by closing the first fuel valve 33, opening the second fuel valve 34, opening the gate valve, and opening the mixing ratio regulating valve 35v after the mixed-fuel co-combustion step S2c.

In the present aspect, as in the operation method according to the fourth aspect, in addition to the first fuel switching step, the fourth fuel switching step can also be executed, and the fuel switching mode can be changed as appropriate.
(14) A fourteenth aspect relates to the gas turbine equipment according to any one of the seventh to thirteenth aspects, in which the combustor 20 includes a plurality of burner groups 26.

The plurality of burner groups 26 each include the first burner 27a and the plurality of second burners 27b disposed around the first burner 27a.
(15) A fifteenth aspect relates to the gas turbine equipment according to any one of the eighth, eleventh, and twelfth aspects, in which the combustor 20 includes a plurality of burner groups 26.

The plurality of burner groups 26 include an inner burner group 26i and a plurality of outer burner groups 26o disposed around the inner burner group 26i. The plurality of burner groups 26 each include the first nozzle 29a and the second nozzles 29b disposed around the first nozzle 29a. The first side second nozzles 29bi are the second nozzles 29b included in the inner burner group 26i. The second side second nozzles 29bo are the second nozzles 29b included in each of the plurality of outer burner groups 26o.

### INDUSTRIAL APPLICABILITY

According to the aspects of the present disclosure, the stable fuel combustion is enabled even during the fuel switching process.

### REFERENCE SIGNS LIST

1: gas turbine
2: gas turbine rotor
3: intermediate casing
10: compressor
11: compressor rotor
12: compressor casing
15: turbine
16: turbine rotor
17: turbine casing
20: combustor
21: outer cylinder
22: end cover
23: inner cylinder
24: air hole plate
24h: air hole
25: combustion cylinder (or simply cylinder)
26: burner group
26i: inner burner group
26o: outer burner group
27: burner
27a: first burner
27b: second burner
28: air flow channel frame
28a: first air flow channel frame
28b: second air flow channel frame
29: nozzle
29a: first nozzle
29b: second nozzle
29bi: first side second nozzle
29bo: second side second nozzle
30: fuel supply system
31: first fuel line
32: second fuel line
33: first fuel valve
34: second fuel valve
34a: downstream second fuel valve
35: connection line
35v: mixing ratio regulating valve
36: header line
36a: first header portion
36b: second header portion
36bi: first side second header portion
36bo: second side second header portion
36x: integrated line
37a: first gate valve (or simply gate valve)
37b: second gate valve
38: branch line
38a: first branch line
38b: second branch line
38bi: first side second branch line
38bo: second side second branch line
39: nozzle valve
50: control device
51: heat generation amount calculator
52: valve control amount calculator
53: valve signal generator
A: air
Acom: compressed air
F: fuel
CG: combustion gas
NG: first fuel
HG: second fuel
Ar: rotor axis
Ac: combustor axis
Da: rotor axial direction
Dau: axial upstream side
Dad: axial downstream side
Dc: combustor axial direction
Dcb: base end side
Det: tip side

1. An operation method of a gas turbine including
a compressor capable of compressing air to generate compressed air,
a combustor capable of burning fuel in the compressed air to generate combustion gas, and
a turbine capable of being driven by the combustion gas, in which
the combustor includes a cylinder in which the fuel is capable of being burned, and a plurality of burners capable of injecting the fuel into the cylinder together with the compressed air,
the plurality of burners include a first burner and a plurality of second burners excluding the first burner, and
the first burner and the plurality of second burners each include an air flow channel frame capable of allowing the air to flow and capable of injecting the air into the cylinder, and a nozzle capable of injecting the fuel into the air flow channel frame,
the operation method comprising:
executing a fuel switching step of switching the fuel to be supplied to the combustor from a first fuel to a second fuel, wherein
the fuel switching step includes
a first-fuel-exclusive combustion step of supplying only the first fuel to a first nozzle that is the nozzle of the first burner, and not supplying the first fuel and the second fuel to second nozzles that are the respective nozzles of the plurality of second burners,
a co-combustion step of supplying only the first fuel to the first nozzle and supplying only the second fuel to the second nozzles after the first-fuel-exclusive combustion step,
a second-fuel-exclusive combustion preparation step of not supplying the first fuel and the second fuel to the first nozzle and supplying the second fuel only to the second nozzles after the co-combustion step, and
a second-fuel-exclusive combustion step of supplying only the second fuel to the first nozzle and the second nozzles after the second-fuel-exclusive combustion preparation step.

2. The operation method of a gas turbine according to claim 1, further comprising:
executing a second fuel switching step in addition to a first fuel switching step that is the fuel switching step, wherein
the second fuel switching step includes
a first-fuel-exclusive combustion step of supplying only the first fuel to first side second nozzles that are some of the respective second nozzles of the plurality of second burners, and to the first nozzle, and not supplying the first fuel and the second fuel to a plurality of second side second nozzles excluding the first side second nozzles among the respective second nozzles of the plurality of second burners,
a co-combustion step of supplying only the first fuel to the first nozzle and supplying only the second fuel to the second nozzles after the first-fuel-exclusive combustion step,
a second-fuel-exclusive combustion preparation step of not supplying the first fuel and the second fuel to the first nozzle and supplying the second fuel only to the second side second nozzles after the co-combustion step, and
a second-fuel-exclusive combustion step of supplying only the second fuel to the first nozzle and the second side second nozzles after the second-fuel-exclusive combustion preparation step.

3. The operation method of a gas turbine according to claim 1, further comprising:
executing a third fuel switching step in addition to a first fuel switching step that is the fuel switching step, wherein
the third fuel switching step includes
a first-fuel-exclusive combustion step of supplying only the first fuel to first side second nozzles that are some of the respective second nozzles of the plurality of second burners, and to the first nozzle, and not supplying the first fuel and the second fuel to a plurality of second side second nozzles excluding the first side second nozzles among the respective second nozzles of the plurality of second burners,
a co-combustion step of supplying only the first fuel to the first nozzle and the first side second nozzles and supplying only the second fuel to the second side second nozzles after the first-fuel-exclusive combustion step,
a second-fuel-exclusive combustion preparation step of not supplying the first fuel and the second fuel to the first nozzle and supplying the second fuel only to the second side second nozzles after the co-combustion step, and
a second-fuel-exclusive combustion step of supplying only the second fuel to the first nozzle and the second side second nozzles after the second-fuel-exclusive combustion preparation step.

4. The operation method of a gas turbine according to claim 1, further comprising:
executing a fourth fuel switching step in addition to a first fuel switching step that is the fuel switching step, wherein
the fourth fuel switching step includes
a first-fuel-exclusive combustion step of supplying only the first fuel to the first nozzle and the second nozzles,
a mixed-fuel co-combustion step of supplying a mixed fuel in which the first fuel and the second fuel are mixed, to the first nozzle and the second nozzles after the first-fuel-exclusive combustion step, and
a second-fuel-exclusive combustion step of supplying only the second fuel to the first nozzle and the second nozzles after the mixed-fuel co-combustion step.

5. The operation method of a gas turbine according to claim 1, wherein
the combustor includes a plurality of burner groups,
the plurality of burner groups each include the first nozzle and the second nozzles disposed around the first nozzle,
the first fuel is natural gas, and
the second fuel is hydrogen gas.

6. The operation method of a gas turbine according to claim 2, wherein
the combustor includes a plurality of burner groups,
the plurality of burner groups include an inner burner group and a plurality of outer burner groups disposed around the inner burner group,
the plurality of burner groups each include the first nozzle and the second nozzles disposed around the first nozzle,
the first side second nozzles are the second nozzles included in the inner burner group,
the plurality of second side second nozzles are the second nozzles included in each of the plurality of outer burner groups,
the first fuel is natural gas, and
the second fuel is hydrogen gas.

7. Gas turbine equipment comprising:
a compressor capable of compressing air to generate compressed air;
a combustor capable of burning fuel in the compressed air to generate combustion gas;
a turbine capable of being driven by the combustion gas; and
a fuel supply system capable of supplying a first fuel and a second fuel to the combustor, wherein
the combustor includes a cylinder in which the fuel is capable of being burned, and a plurality of burners capable of injecting the fuel into the cylinder together with the compressed air,
the plurality of burners include a first burner and a plurality of second burners excluding the first burner,
the first burner and the plurality of second burners each include an air flow channel frame capable of allowing the air to flow and capable of injecting the air into the cylinder, and a nozzle capable of injecting the fuel into the air flow channel frame,
the fuel supply system includes
a first fuel line connected to a supply source of the first fuel and through which the first fuel is capable of flowing,
a second fuel line connected to a supply source of the second fuel and through which the second fuel is capable of flowing,
a first fuel valve provided in the first fuel line,
a second fuel valve provided in the second fuel line,
a header line through which the first fuel and the second fuel are capable of flowing,
branch lines that branch from the header line to each of the plurality of burners, and
a gate valve provided in the header line and capable of partitioning the header line into a first header portion and a second header portion,
first branch lines that are some of the respective branch lines of the plurality of burners branch from the first header portion,
the first branch lines are connected to a first nozzle that is the nozzle of the first burner,
a plurality of second branch lines excluding the first branch lines among the respective branch lines of the plurality of burners branch from the second header portion,
each of the plurality of second branch lines is connected to a second nozzle that is the nozzle of each of the plurality of second burners,
the first fuel line is connected to the first header portion, and
the second fuel line is connected to the second header portion.

8. The gas turbine equipment according to claim 7, further comprising:
a second gate valve provided in the second header portion and capable of partitioning the second header portion into a first side second header portion on a side of the first header portion and a second side second header portion that is a remaining portion of the second header portion, in addition to a first gate valve that is the gate valve, wherein
first side second branch lines that are some of the plurality of second branch lines branch from the first side second header portion,
first side second nozzles that are some of the respective second nozzles of the plurality of second burners are connected to the first side second branch lines,
a plurality of second side second branch lines that are the second branch lines excluding the first side second branch lines among the plurality of second branch lines branch from the second side second header portion,
second side second nozzles that are the second nozzles excluding the first side second nozzles among the respective second nozzles of the plurality of second burners are connected to the second side second branch lines, and
the second fuel line is connected to the second side second header portion.

9. The gas turbine equipment according to claim 7, further comprising:
a connection line that connects a position in the first fuel line between a position at which the first fuel line is connected to the header line and a position at which the first fuel valve is provided, and a position in the second fuel line between a position at which the second fuel line is connected to the header line and a position at which the second fuel valve is provided; and
a mixing ratio regulating valve provided in the connection line and capable of regulating a flow rate of the fuel that flows through the connection line.

10. The gas turbine equipment according to claim 7, further comprising:
a control device, wherein
the control device is capable of executing a fuel switching step of switching the fuel to be supplied to the combustor from the first fuel to the second fuel by controlling the first fuel valve, the second fuel valve, and the gate valve, and
the fuel switching step includes
a first-fuel-exclusive combustion step of supplying only the first fuel to the first nozzle and not supplying the first fuel and the second fuel to the second nozzles by opening the first fuel valve, closing the second fuel valve, and closing the gate valve,
a co-combustion step of supplying only the first fuel to the first nozzle and supplying only the second fuel to the second nozzles by opening the first fuel valve, opening the second fuel valve, and closing the gate valve after the first-fuel-exclusive combustion step,
a second-fuel-exclusive combustion preparation step of not supplying the first fuel and the second fuel to the first nozzle and supplying the second fuel only to the second nozzles by closing the first fuel valve, opening the second fuel valve, and closing the gate valve after the co-combustion step, and
a second-fuel-exclusive combustion step of supplying only the second fuel to the first nozzle and the second nozzles by closing the first fuel valve, opening the second fuel valve, and opening the gate valve after the second-fuel-exclusive combustion preparation step.

11. The gas turbine equipment according to claim 8, further comprising:
a control device, wherein
the control device is capable of executing first and second fuel switching steps of switching the fuel to be supplied to the combustor from the first fuel to the second fuel by controlling the first fuel valve, the second fuel valve, the first gate valve, and the second gate valve,
the first fuel switching step includes
a first-fuel-exclusive combustion step of supplying only the first fuel to the first nozzle and not supplying the first fuel and the second fuel to the second nozzles by opening the first fuel valve, closing the second fuel valve, closing the first gate valve, and opening the second gate valve,
a co-combustion step of supplying only the first fuel to the first nozzle and supplying only the second fuel to the second nozzles by opening the first fuel valve, opening the second fuel valve, closing the first gate valve, and opening the second gate valve after the first-fuel-exclusive combustion step,
a second-fuel-exclusive combustion preparation step of not supplying the first fuel and the second fuel to the first nozzle and supplying the second fuel only to the second nozzles by closing the first fuel valve, opening the second fuel valve, closing the first gate valve, and opening the second gate valve after the co-combustion step, and
a second-fuel-exclusive combustion step of supplying only the second fuel to the first nozzle and the second nozzles by closing the first fuel valve, opening the second fuel valve, opening the first gate valve, and opening the second gate valve after the second-fuel-exclusive combustion preparation step, and
the second fuel switching step includes
a first-fuel-exclusive combustion step of supplying only the first fuel to the first nozzle and the first side second nozzles and not supplying the first fuel and the second fuel to the second side second nozzles by opening the first fuel valve, closing the second fuel valve, opening the first gate valve, and closing the second gate valve,
a co-combustion step of supplying only the first fuel to the first nozzle and supplying only the second fuel to the second nozzles by opening the first fuel valve, opening the second fuel valve, closing the first gate valve, and opening the second gate valve after the first-fuel-exclusive combustion step,
a second-fuel-exclusive combustion preparation step of not supplying the first fuel and the second fuel to the first nozzle and supplying the second fuel only to the second nozzles by closing the first fuel valve, opening the second fuel valve, closing the first gate valve, and opening the second gate valve after the co-combustion step, and
a second-fuel-exclusive combustion step of supplying only the second fuel to the first nozzle and the second nozzles by closing the first fuel valve, opening the second fuel valve, opening the first gate valve, and opening the second gate valve after the second-fuel-exclusive combustion preparation step.

12. The gas turbine equipment according to claim 8, further comprising:
a control device, wherein
the control device is capable of executing first and third fuel switching steps of switching the fuel to be supplied to the combustor from the first fuel to the second fuel by controlling the first fuel valve, the second fuel valve, the first gate valve, and the second gate valve,
the first fuel switching step includes
a first-fuel-exclusive combustion step of supplying only the first fuel to the first nozzle and not supplying the first fuel and the second fuel to the second nozzles by opening the first fuel valve, closing the second fuel valve, closing the first gate valve, and opening the second gate valve,
a co-combustion step of supplying only the first fuel to the first nozzle and supplying only the second fuel to the second nozzles by opening the first fuel valve, opening the second fuel valve, closing the first gate valve, and opening the second gate valve after the first-fuel-exclusive combustion step,
a second-fuel-exclusive combustion preparation step of not supplying the first fuel and the second fuel to the first nozzle and supplying the second fuel only to the second nozzles by closing the first fuel valve, opening the second fuel valve, closing the first gate valve, and opening the second gate valve after the co-combustion step, and
a second-fuel-exclusive combustion step of supplying only the second fuel to the first nozzle and the second nozzles by closing the first fuel valve, opening the second fuel valve, opening the first gate valve, and opening the second gate valve after the second-fuel-exclusive combustion preparation step, and
the third fuel switching step includes
a first-fuel-exclusive combustion step of supplying only the first fuel to the first nozzle and the first side second nozzles and not supplying the first fuel and the second fuel to the second side second nozzles by opening the first fuel valve, closing the second fuel valve, opening the first gate valve, and closing the second gate valve,
a co-combustion step of supplying only the first fuel to the first nozzle and the first side second nozzles and supplying only the second fuel to the second side second nozzles by opening the first fuel valve, opening the second fuel valve, opening the first gate valve, and closing the second gate valve after the first-fuel-exclusive combustion step,
a second-fuel-exclusive combustion preparation step of not supplying the first fuel and the second fuel to the first nozzle and supplying the second fuel only to the second nozzles by closing the first fuel valve, opening the second fuel valve, closing opening the first gate valve, and opening the second gate valve after the co-combustion step, and
a second-fuel-exclusive combustion step of supplying only the second fuel to the first nozzle and the second nozzles by closing the first fuel valve, opening the second fuel valve, opening the first gate valve, and opening the second gate valve after the second-fuel-exclusive combustion preparation step.

13. The gas turbine equipment according to claim 9, further comprising:
a control device, wherein
the control device is capable of executing first and fourth fuel switching steps of switching the fuel to be supplied to the combustor from the first fuel to the second fuel by controlling the first fuel valve, the second fuel valve, the gate valve, and the mixing ratio regulating valve,
the first fuel switching step includes
a first-fuel-exclusive combustion step of supplying only the first fuel to the first nozzle and not supplying the first fuel and the second fuel to the second nozzles by opening the first fuel valve, closing the second fuel valve, closing the gate valve, and closing the mixing ratio regulating valve,
a co-combustion step of supplying only the first fuel to the first nozzle and supplying only the second fuel to the second nozzles by opening the first fuel valve, opening the second fuel valve, closing the gate valve, and closing the mixing ratio regulating valve after the first-fuel-exclusive combustion step,
a second-fuel-exclusive combustion preparation step of not supplying the first fuel and the second fuel to the first nozzle and supplying the second fuel only to the second nozzles by closing the first fuel valve, opening the second fuel valve, closing the gate valve, and closing the mixing ratio regulating valve after the co-combustion step, and
a second-fuel-exclusive combustion step of supplying only the second fuel to the first nozzle and the second nozzles by closing the first fuel valve, opening the second fuel valve, opening the gate valve, and closing the mixing ratio regulating valve after the second-fuel-exclusive combustion preparation step, and
the fourth fuel switching step includes
a first-fuel-exclusive combustion step of supplying only the first fuel to the first nozzle and the second nozzles by opening the first fuel valve, closing the second fuel valve, opening the gate valve, and closing the mixing ratio regulating valve,
a mixed-fuel co-combustion step of supplying a mixed fuel in which the first fuel and the second fuel are mixed, to the first nozzle and the second nozzles by opening the first fuel valve, opening the second fuel valve, opening the gate valve, and opening the mixing ratio regulating valve after the first-fuel-exclusive combustion step, and
a second-fuel-exclusive combustion step of supplying only the second fuel to the first nozzle and the second nozzles by closing the first fuel valve, opening the second fuel valve, opening the gate valve, and closing the mixing ratio regulating valve after the mixed-fuel co-combustion step.

14. The gas turbine equipment according to claim 7, wherein
the combustor includes a plurality of burner groups, and
the plurality of burner groups each include the first burner and the plurality of second burners disposed around the first burner.

15. The gas turbine equipment according to claim 8, wherein
the combustor includes a plurality of burner groups,
the plurality of burner groups include an inner burner group and a plurality of outer burner groups disposed around the inner burner group,
the plurality of burner groups each include the first nozzle and the second nozzles disposed around the first nozzle,
the first side second nozzles are the second nozzles included in the inner burner group, and
the second side second nozzles are the second nozzles included in each of the plurality of outer burner groups.
